(19) United States
(12) Patent Application Publication
(10) Pub. No.: US 2021/0037248 A1
(43) Pub. Date: Feb. 4, 2021

(54) IMAGE ENCODING DEVICE, IMAGE ENCODING METHOD, IMAGE DECODING DEVICE, AND IMAGE DECODING METHOD

(71) Applicant: SONY CORPORATION, Tokyo (JP)

(72) Inventor: Kenji KONDO, Tokyo (JP)

(73) Assignee: SONY CORPORATION, Tokyo (JP)

(21) Appl. No.: 17/040,836

(22) PCT Filed: Mar. 18, 2019
(86) PCT No.: PCT/JP2019/011046

§ 371 Date: Sep. 23, 2020

(30) Foreign Application Priority Data
Mar. 30, 2018 (JP) 2018-068829

(51) Int. Cl. H04N 19/159; H04N 19/82; H04N 19/117; H04N 19/176

(52) U.S. Cl. CPC H04N 19/159; H04N 19/176; H04N 19/117; H04N 19/82

(57) ABSTRACT

There is provided an image encoding device, an image encoding method, an image decoding device, and an image decoding method by which the processing amount of an inter-prediction process using sub-blocks can be reduced. In the encoding device, identification information for identifying a sub-block size which represents the size of a sub-block to be used in an inter-prediction process is set, switching to a sub-block having the size is performed, and the inter-prediction process is performed to encode an image, whereby a bitstream including the identification information is generated. In the image decoding device, the identification information is parsed from the bitstream, switching to a sub-block having a size according to the identification information is performed, and an inter-prediction process is performed to decode the bitstream, whereby an image is generated. The present technique is applicable to an image encoding device for encoding images or to an image decoding device for decoding images, etc., for example.

### TECHNICAL FIELD

The present disclosure relates to an image encoding device, an image encoding method, an image decoding device, and an image decoding method, and particularly, relates to an image encoding device, an image encoding method, an image decoding device, and an image decoding method by which the processing amount of an inter-prediction process using sub-blocks can be reduced.

### BACKGROUND ART

In JVET (Joint Video Exploration Team) for searching for a next-generation video code in ITU-T (International Telecommunication Union Telecommunication Standardization Sector), an inter-prediction process (Affine motion compensation (MC) prediction) of performing motion compensation by performing an affine transformation of a reference image on the basis of a motion vector of a vertex of a sub-block has been proposed (for example, see NPL 1). According to such an inter-prediction process, not only a translation (parallel translation) between screens but also more complicated movement such as rotations, scaling (enlargement/reduction), or what is called skew can be predicted. Thus, it is expected that improvement in the prediction quality leads to improvement in the encoding efficiency.

### CITATION LIST

### Non Patent Literature

### [NPL 1]

Jianle Chen, Elena Alshina, Gary J. Sullivan, Jens-Rainer, JillBoyce, “Algorithm Description of Joint Exploration Test Model 4,” JVET-G1001_v1, Joint Video Exploration Team (JVET) of ITU-T SG 16 WP 3 and ISO/IEC JTC 1/SC 29/WG 11 7th Meeting: Torino, IT, 13-21 Jul. 2017

### SUMMARY

### Technical Problem

However, in such an inter-prediction process using sub-blocks, when a sub-block size is made smaller, more sub-blocks need to be processed. Accordingly, there is concern for an increase in the processing amount for executing encoding or decoding.

The present disclosure has been achieved in view of the above-mentioned circumstances and enables reduction in the processing amount of an inter-prediction process using sub-blocks.

### Solution to Problem

An image encoding device according to a first aspect of the present disclosure includes a setting section that sets identification information for identifying a sub-block size which represents a size of a sub-block to be used in an inter-prediction process of an image, and an encoding section that performs switching to the sub-block having the size set by the setting section, encodes the image by performing the inter-prediction process, and generates a bitstream including the identification information.

An image encoding method according to the first aspect of the present disclosure includes causing an image encoding device, which encodes an image, to set identification information for identifying a sub-block size which represents a size of a sub-block to be used in an inter-prediction process of the image, and causing the image encoding device to perform switching to the sub-block having the size according to the setting, encode the image by performing the inter-prediction process, and generate a bitstream including the identification information.

In the first aspect of the present disclosure, identification information for identifying the sub-block size which represents the size of a sub-block to be used in the inter-prediction process of the image is set, switching to the sub-block having a size according to the setting is performed, and the inter-prediction process is performed to encode the image, whereby a bitstream including the identification information is generated.

An image decoding device according to a second aspect of the present disclosure includes a parse section that parses identification information for identifying a sub-block size, from a bitstream including the identification information, the sub-block size representing a size of a sub-block to be used in an inter-prediction process of an image, and a decoding section that performs switching to the sub-block having the size according to the identification information parsed by the parse section, performs the inter-prediction process to decode the bitstream, and generates the image.

An image decoding method according to the second aspect of the present disclosure includes causing an image decoding device, which decodes an image, to parse identification information for identifying a sub-block size, from a bitstream including the identification information, the sub-block size representing a size of a sub-block to be used in an inter-prediction process of the image, and causing the image decoding device to perform switching to the sub-block having the size according to the parsed identification information, perform the inter-prediction process to decode the bitstream, and generate the image.

In the second aspect of the present disclosure, identification information for identifying a sub-block size which represents the size of a sub-block to be used in a inter-prediction process of an image is parsed from a bitstream including the identification information, switching to a sub-block having the size according to the identification information is performed, and the inter-prediction process is performed to decode the bitstream, whereby the image is generated.

### Advantageous Effect of Invention

According to the first and second aspects of the present disclosure, the processing amount of an inter-prediction process using sub-blocks can be reduced.

It is to be noted that effect is not necessarily limited to those described. Any of the effects described in the present disclosure may be provided.

### BRIEF DESCRIPTION OF DRAWINGS

FIG. 1 is a block diagram depicting a configuration example of one embodiment of an image processing system to which the present technique is applied.

FIG. 2 is an explanatory diagram of processes which are performed in an encoding circuit.

FIG. 3 is an explanatory diagram of processes which are performed in a decoding circuit.

FIG. 4 is an explanatory diagram of an affine transformation that involves a rotation operation.

FIG. 5 is an explanatory diagram of Bi-prediction interpolation filtering.

FIG. 6 is an explanatory diagram of adopting an interpolation filter in a case where a tap length is shortened.

FIG. 7 is a block diagram depicting a configuration example of one embodiment of an image encoding device.

FIG. 8 is a block diagram depicting a configuration example of one embodiment of an image decoding device.

FIG. 9 is a flowchart for explaining an image encoding process.

FIG. 10 is a flowchart for explaining a first processing example of setting sub-block size identification information.

FIG. 11 is a flowchart for explaining a second processing example of setting sub-block size identification information.

FIG. 12 is a flowchart for explaining a first processing example of switching the tap length of an interpolation filter.

FIG. 13 is a flowchart for explaining a second processing example of switching the tap length of an interpolation filter.

FIG. 14 is a flowchart for explaining an image decoding process.

FIG. 15 is a block diagram depicting a configuration example of one embodiment of a computer to which the present technique is applied.

### DESCRIPTION OF EMBODIMENTS

<Documents, Etc. For Supporting Technical Matters and Technical Terms>

The scope disclosed by the present technique encompasses not only embodiments described below but also the disclosures in the following NPLs, which have been publicly known at the time of filing of the present application.

NPL 1: (See the above)

NPL 2: TELECOMMUNICATION STANDARDIZATION SECTOR OF ITU (International Telecommunication Union), “High efficiency video coding,” H.265, 12/2016

NPL 3: TELECOMMUNICATION STANDARDIZATION SECTOR OF ITU (International Telecommunication Union), “Advanced video coding for generic audiovisual services,” H.264, 04/2017

That is, the disclosures in the above NPLs 1 to 3 constitute the grounds for determining the support requirements. For example, even in a case where a QTBT (Quad Tree Plus Binary Tree) Block Structure disclosed in NPL 1 or a QT (Quad-Tree) Block Structure disclosed in NPL 2 is not directly described in the embodiment, these block structures fall within the scope of the disclosure of the present technique, and are considered to satisfy the support requirements of the claims. In addition, similarly, in a case where the embodiment fail to include any direct description of the technical terms “Parsing,” “Syntax,” “Semantics,” etc., for example, these terms fall within the scope of the disclosure of the present technique, and are considered to satisfy the support requirements of the claims.

### Terms

In the present application, the following terms are defined as follows.

<Block>

A partial region of an image (picture) or a “block” (which does not mean a block representing a processing section) which an explanation uses as a unit of processing represents any partial region of a picture, unless specifically mentioned, and the size, shape, and characteristics, etc. of the region is not particularly limited. For example, the “block” encompasses any partial regions (units of processing) such as a TB (Transform Block), TU (Transform Unit), a PB (Prediction Block), a PU (Prediction Unit), an SCU (Smallest Coding Unit), a CU (Coding Unit), an LCU (Largest Coding Unit), a CTB (Coding TreeBlock), a CTU (Coding Tree Unit), a transformation block, a sub-block, a macroblock, a tile, and a slice.

<Designating Block Size>

To designate the size of such a block, the block size may be directly designated, or may be indirectly designated. For example, identification information for identifying the size may be used to designate the block size. In addition, for example, the ratio to or the difference from the size of a reference block (e.g., LCU, SCU, or the like) may be used to designate the block size. For example, in a case where information for designating the block size as a syntax element or the like is transmitted, information for indirectly designating the size in either of the above-mentioned manners may be used. As a result of this, the information amount of the information can be reduced, whereby the encoding efficiency can be improved in some cases. Moreover, this designation of the block size encompasses designation of the range of the block size (e.g., designation of an allowable range of the block size or the like).

<Units of Information/Processing>

A data unit by which various types of information are set, and a data unit which is a target of various processes can be optionally defined, and thus, are not limited to the above-mentioned examples. For example, information regarding these data units and a process of these data units may be set for each TU (Transform Unit), TB (Transform Block), PU (Prediction Unit), PB (Prediction Block), CU (Coding Unit), LCU (Largest Coding Unit), sub-block, block, tile, slice, picture, sequence, or component. Alternatively, data on these data units may be set as targets. It goes without saying that a data unit can be set for each type of information or each process, and thus, all data units of information or processing do not need to be uniformly set. It is to be noted that a place for storing the information is optionally defined, and thus, the information may be stored in a head of the above-mentioned data unit, a parameter set, or the like. Further, the information may be stored in multiple places.

<Control Information>

Control information regarding the present technique may be transmitted from an encoding side to a decoding side. For example, control information (e.g., enabled_flag) for controlling whether or not to permit (or prohibit) application of the above-mentioned present technique may be transmitted. Also, for example, control information indicating a target to which the above-mentioned present technique is applied (or a target to which the above-mentioned present technique is not applied) may be transmitted. For example, control information for designating (the upper limit, the lower limit, or both of them of) a block size, a frame, a component, a layer, or the like, to which the present technique is applied (or a target for which application of the above-mentioned present technique is permitted or prohibited) may be transmitted.

<Flag>

It is to be noted that a “flag” in the present specification refers to information for identifying a plurality of states. The information encompasses not only information for identifying two conditions: true (1) or false (0), but also information for enabling identification of three or more states. Therefore, a value that can be taken by the “flag” may be two values: 1/0, or may be three or more values, for example. That is, the number of bits constituting the “flag” is optionally defined, and thus, may be one bit or two or more bits. Also, it can be assumed that identification information (including the flag) may be contained in a bitstream, or differential information of the identification information with respect to certain reference information may be contained in a bitstream. Therefore, in the present specification, a “flag” and “identification information” encompass not only information regarding the flag itself and the identification information, but also differential information thereof with respect to reference information.

<Associating Metadata>

In addition, any form can be adopted for transmission or recording of various types of information (metadata, etc.) regarding encoded data (a bitstream) as long as the information is associated with the encoded data. Here, the term “associate” means enabling processing one data set while the other data set is available (linkable), for example. That is, data sets associated with each other may be integrated to one data set or may be left separate from each other. For example, information associated with encoded data (image) may be transmitted on a transmission path different from that for the encoded data (image). Further, for example, information associated with encoded data (image) may be recorded into a recording medium different from that for the encoded data (image) (or into another recording area in the same recording medium). It is to be noted that “associating” may be performed not on the entirety of data but on a part of data. For example, an image and information corresponding to the image may be associated with each other by any units such as multiple frames, one frame, or a part of a frame.

It is to be noted that, in the present specification, terms “synthesize,” “multiplex,” “add,” “integrate,” “include,” “store,” “put into,” “introduce,” “insert,” etc., each mean getting a plurality of things together, such as integrating encoded data and metadata into one data set, and each mean one method for the above-mentioned “associating.” In addition, in the present specification, encoding encompasses entire processing of converting an image into a bitstream, but also a part of the processing. For example, encoding encompasses not only processing including a prediction process, an orthogonal transformation, quantization, arithmetic encoding, etc., but also processing including quantization and arithmetic encoding, processing including a prediction process, quantization, and arithmetic encoding, and the like. Similarly, decoding encompasses not only entire processing of converting a bitstream into an image, but also a part of the processing. For example, decoding encompasses not only processing including inverse arithmetic decoding, inverse quantization, an inverse orthogonal transformation, a prediction process, and the like, but also processing including inverse arithmetic decoding and inverse quantization, processing including inverse arithmetic decoding, inverse quantization, and a prediction process, and the like.

Hereinafter, specific embodiments to which the present technique is applied will be explained in detail with reference to the drawings.

<Outline of Present Technique>

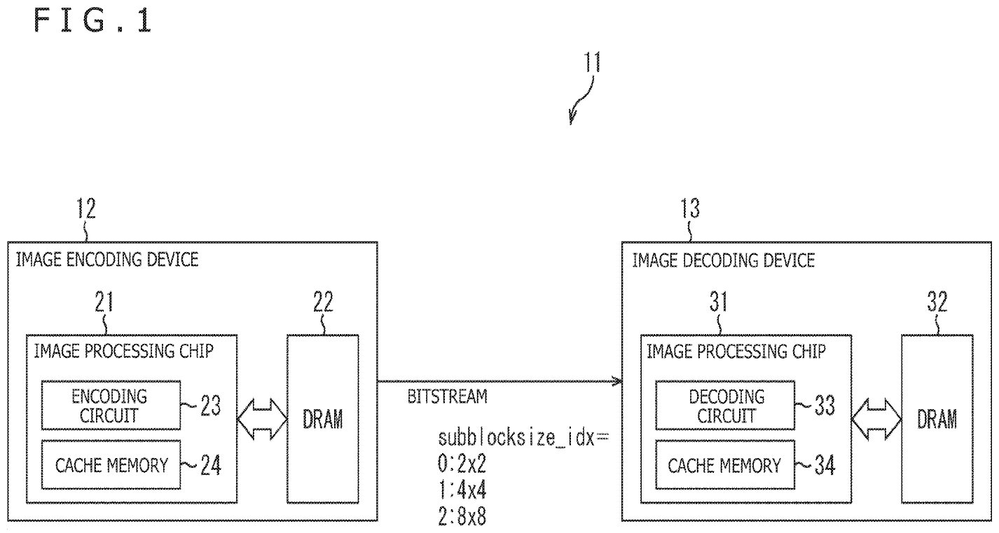

The outline of the present technique will be explained with reference to FIGS. 1 to 6.

FIG. 1 is a block diagram depicting a configuration example of one embodiment of an image processing system to which the present technique is applied.

As depicted in FIG. 1, an image processing system 11 includes an image encoding device 12 and an image decoding device 13. For example, in the image processing system 11, an image captured by an imaging device (not depicted) is inputted to the image encoding device 12, and the image is encoded by the image encoding device 12 so that encoded data is generated. As a result of this, in the image processing system 11, the encoded data is transmitted, in the form of a bitstream, from the image encoding device 12 to the image decoding device 13. Then, in the image processing system 11, the encoded data is decoded by the image decoding device 13 so that an image is generated, and then, is displayed on a display device (not depicted).

The image encoding device 12 has a configuration in which an image processing chip 21 and an external memory 22 are connected to each other via a bus.

The image processing chip 21 includes an encoding circuit 23 that encodes an image, and a cache memory 24 that temporarily stores data necessary for the encoding circuit 23 to encode an image.

The external memory 22 includes a DRAM (Dynamic Random Access Memory), for example, and stores image data, which is to be encoded in the image encoding device 12, by units of processing (e.g., frames) which is performed in the image processing chip 21. It is to be noted that, in a case where the QTBT (Quad Tree Plus Binary Tree) Block Structure disclosed in Non Patent Literature 1 or the QT (Quad-Tree) Block Structure disclosed in Non Patent Literature 2 is adopted as the Block Structure, image data is stored into the external memory 22 by, as a unit of processing, a CTB (Coding TreeBlock), a CTU (Coding Tree Unit), a PB (Prediction Block), a PU (Prediction Unit), a CU (Coding Unit), or a CB (Coding Block). It is preferable that a CTB or a CTU, which is a unit of processing having a fixed sequence-level block size, is adopted as a unit of processing.

For example, in the image encoding device 12, data obtained by dividing one frame (or CTB) of image data stored in the external memory 22, into sub-blocks which are units of processing to be used in an inter-prediction process is read to the cache memory 24. Further, in the image encoding device 12, the encoding circuit 23 encodes each of the sub-blocks stored in the cache memory 24 so that encoded data is generated.

Here, in the image processing system 11, sub-block size identification information for identifying a sub-block size is set at the encoding circuit 23, and a bitstream including the sub-block size identification information is transmitted from the image encoding device 12 to the image decoding device 13. For example, in a case where a sub-block size is 2×2, 0 is set as the sub-block size identification information. Similarly, in a case where a sub-block size is 4×4, 1 is set as the sub-block size identification information. In a case where a sub-block size is 8×8, 2 is set as the sub-block size identification information. Alternatively, a sub-block having a size of at least 16×16 may be used. It is to be noted that a rectangular sub-block that is not a square may be used, and, in a case where a rectangle that is long in the lateral direction is used, access to the external memory 22 can be made at high speed. In short, any expression form can be used for the sub-block size identification information as long as a sub-block size or shape can be identified by the sub-block size identification information.

In the image decoding device 13, an image processing chip 31 and an external memory 32 are connected to each other via a bus.

The image processing chip 31 includes a decoding circuit 33 that generates an image by decoding encoded data, and a cache memory 34 that temporarily stores data necessary for the decoding circuit 33 to decode encoded data.

The external memory 32 includes a DRAM, for example, and stores each image frame of encoded data which is a target to be decoded in the image decoding device 13.

For example, in the image decoding device 13, sub-block size identification information is parsed from a bitstream, encoded data is read out from the external memory 32 to the cache memory 34 according to a sub-block having a size set in the sub-block size identification information. Further, in the image decoding device 13, each block of the encoded data stored in the cache memory 34 is decoded by the decoding circuit 33 so that an image is generated.

As described above, in the image processing system 11, the image encoding device 12 sets sub-block size identification information for identifying the size of a sub-block, and transmits a bitstream including the sub-block size identification information to the image decoding device 13. For example, in the image processing system 11, the sub-block size identification information (subblocksize_idx) can be defined by a high-level syntax such as a SPS, a PPS, or a SLICE header. Also, from the point of view of a relation with prediction and the improvement in performance, it is preferable that the sub-block size identification information is defined in a SLICE header. From the point of view of simplification in processing and parsing at the image decoding device 13, it is preferable that the sub-block size identification information is defined in a SPS or PPS.

In the image processing system 11, a large-size sub-block is used such that the number of sub-blocks per unit of processing (e.g., 1 frame or 1 CTB), for example, can be reduced. As a result of this, the processing amount of an inter-prediction process, which is performed for each sub-block, can be reduced. Accordingly, for example, in an application for which reduction of a processing amount is demanded, an inter-prediction process is performed by use of a large sub-block so that encoding or decoding can be more reliably performed.

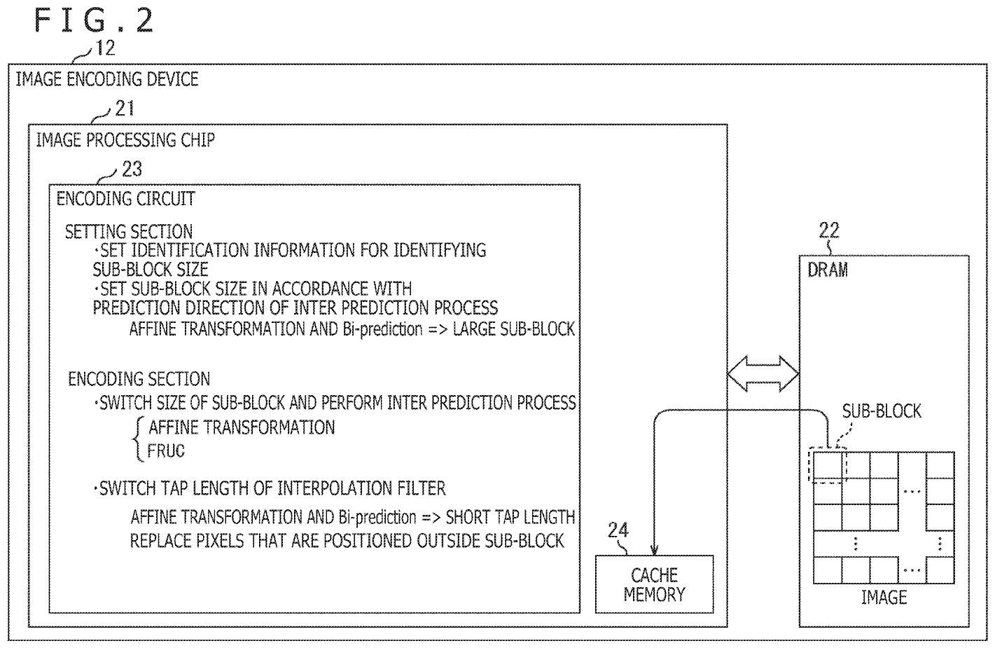

With reference to FIG. 2, an explanation will be further given of processing which is performed by the encoding circuit 23 of the image encoding device 12.

For example, the encoding circuit 23 is designed to function as a setting section and an encoding section such as those depicted in the drawing.

That is, the encoding circuit 23 is capable of performing a setting process of setting sub-block size identification information for identifying a sub-block size (e.g., 2×2, 4×4, 8×8, etc.) which represents the size of a sub-block to be used in an inter-prediction process during image encoding.

Here, in a case where, for example, a processing amount required for an application for executing image encoding in the image encoding device 12 is equal to or less than a predetermined set value, the encoding circuit 23 sets the sub-block size identification information to set a sub-block size to be large. Similarly, in a case where, for example, a processing amount required for an application for executing bitstream decoding in the image decoding device 13 is equal to or less than a predetermined set value, the encoding circuit 23 sets the sub-block size identification information to set a sub-block size to be large. Here, for each of the image encoding device 12 and the image decoding device 13, a set value for defining a processing amount in an application to be executed is previously set in accordance with the processing capability. For example, in a case where encoding or decoding is executed in a mobile terminal having a low processing capability, a low set value according to the processing capability is set.

Moreover, the encoding circuit 23 is capable of setting a sub-block size in accordance with a prediction direction of an inter-prediction process. For example, the encoding circuit 23 sets the sub-block size identification information such that the sub-block size varies in accordance with whether or not a prediction direction of an inter-prediction process is Bi-prediction. In addition, in a case where the prediction direction of the inter-prediction process is Bi-prediction, the encoding circuit 23 sets the sub-block size identification information to set the sub-block size to be large. Alternatively, in a case where an affine transformation is adopted as the inter-prediction process and a prediction direction of the inter-prediction process is Bi-prediction, the encoding circuit 23 sets the sub-block size identification information to set the sub-block size to be large.

In addition, the encoding circuit 23 is capable of performing an encoding process of encoding an image by performing an inter-prediction process while switching the size of a sub-block and generating a bitstream including the sub-block size identification information.

Here, the encoding circuit 23 adopts an affine transformation or FRUC (Frame Rate Up Conversion) to each sub-block, thereby performs the inter-prediction process. Alternatively, the encoding circuit 23 may perform the inter-prediction process by adopting a translation or the like. It is to be noted that the encoding circuit 23 may switch the sub-block size by referring to the sub-block size identification information, or may switch the sub-block size by making a determination in accordance with the above-mentioned prediction direction when performing the inter-prediction process.

In addition, in a case where an affine transformation is adopted as the inter-prediction process for image encoding, the encoding circuit 23 can interpolate pixels during the inter-prediction process by using an interpolation filter having a shortened tap length.

Here, the encoding circuit 23 switches the tap length of an interpolation filter in accordance with the prediction direction of the inter-prediction process and interpolates pixels. For example, in a case where the prediction direction of the inter-prediction process is Bi-prediction the encoding circuit 23 interpolates pixels by using an interpolation filter having a short tap length. Moreover, the encoding circuit 23 switches an interpolation filter such that the tap length of an interpolation filter that is used in a case where an affine transformation is adopted as the inter-prediction process differs from tap length of an interpolation filter that is used in a case where a prediction process (e.g., parallel translation) other than an affine transformation is adopted as the inter-prediction process. Alternatively, in a case where an affine transformation is adopted as the inter-prediction process and the prediction direction of the inter-prediction process is Bi-prediction, the encoding circuit 23 interpolates pixels by using an interpolation filter having a short tap length.

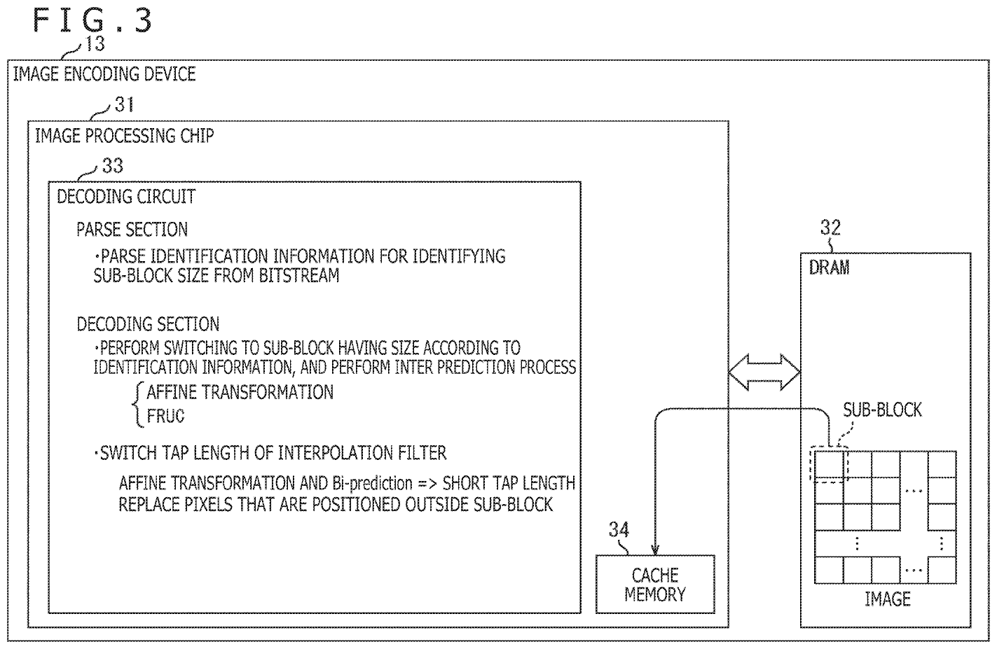

With reference to FIG. 3, an explanation will be further given of processing which is performed by the decoding circuit 33 of the image decoding device 13.

For example, the decoding circuit 33 is designed to function as a parse section and a decoding section such as those depicted in the drawing.

That is, the decoding circuit 33 is capable of performing a parse process of parsing, from a bitstream transmitted from the image encoding device 12, sub-block size identification information representing the size of a sub-block which is used in an inter-prediction process for image decoding.

Further, the decoding circuit 33 is capable of performing a decoding process of performing switching to a sub-block having a size according to the sub-block size identification information and performing the inter-prediction process to decode the bitstream, thereby generating an image. Here, the decoding circuit 33 performs the inter-prediction process according to the affine transformation or FRUC which has been adopted in the inter-prediction process at the encoding circuit 23.

In addition, similar to the encoding circuit 23, the decoding circuit 33 can interpolate pixels by using an interpolation filter having a shortened tap length, in a case where an affine transformation is adopted as the inter-prediction process for image encoding.

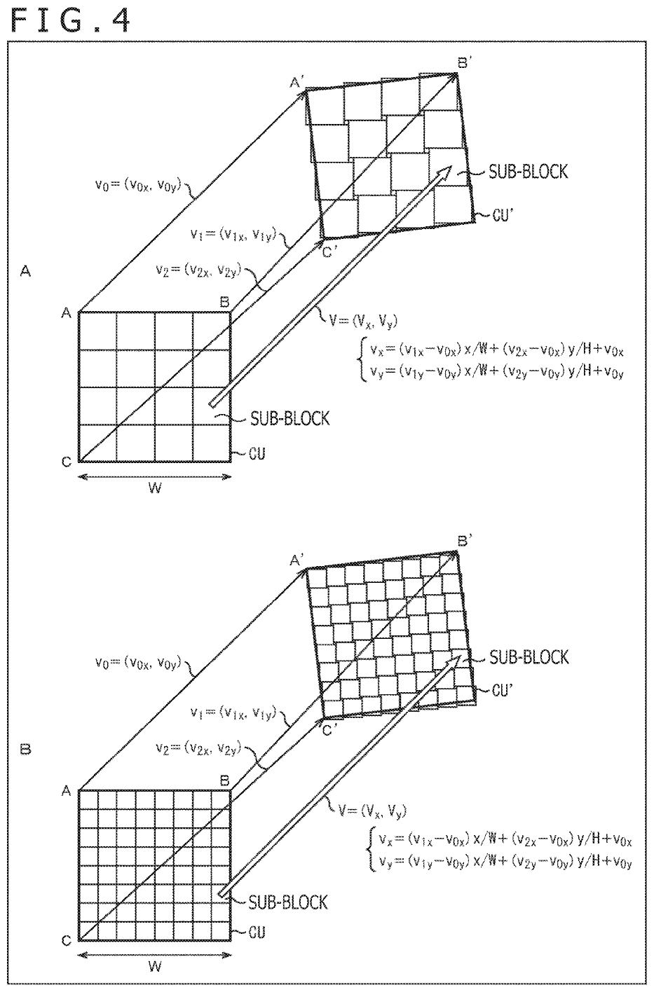

Here, with reference to FIG. 4, an explanation will be given of an affine transformation involving a rotation operation in a coding unit that is divided into sub-blocks having different sizes.

FIG. 4A illustrates one example in which an affine transformation involving a rotation operation is performed for a coding unit that is divided into 4×4=16 sub-blocks. Further, FIG. 4B illustrates one example in which an affine transformation involving a rotation operation is performed for a coding unit that is divided into 8×8=64 sub-blocks.

For example, in motion compensation of an affine transformation, a coding unit CU′ in which a point A′ that is separate from a vertex A by a motion vector v₀ is an upper left vertex, a point B′ that is separate from a vertex B by a motion vector v₁ is an upper right vertex, and a point C′ that is separate from a vertex C by a motion vector v₂ is a lower left vertex, is formed as a reference block in a reference image. An affine transformation of the coding unit CU′ is performed on the basis of the motion vectors v₀ to v₂, whereby motion compensation is performed. Thus, a prediction image of a coding unit CU is generated.

That is, the coding unit CU, which is a process target, is divided into sub-blocks, a motion vector v=(vₓ, v_{y}) for each of the sub-blocks is obtained on the basis of the motion vector v₀=(v₀ₓ, v_{0y}), v₁=(v₁ₓ, v_{1y}) and v₂=(v₂ₓ, v_{2y}) in accordance with expressions depicted in the drawing.

Then, reference sub-blocks the sizes of which are equal to those of sub-blocks that are separate from the corresponding sub-blocks by the motion vectors v in the reference image, are translated on the basis of the motion vectors v. Accordingly, a sub-block-based prediction image of the coding unit CU is generated.

Here, in a case where such an affine transformation involving a rotation operation is performed, division into small-size sub-blocks such as those depicted in FIG. 4B can result in obtainment of a prediction image with higher prediction precision, compared to division into large-size sub-blocks such as those depicted in FIG. 4A. However, division into small-size sub-blocks requires more computations due to an increase of the number of sub-blocks. This increases the processing amount, and also requires more time to read out data from a memory. Therefore, increasing the speed of processing is inhibited.

Thus, when a sub-block size is set to be large particularly in such an affine transformation, the processing amount can be more effectively reduced. Further, the speed of processing can be increased. It is to be noted that, in the above explanation, CU and PU are processed as blocks under the same dimension, but, in a case where CU and PU can constitute blocks under the difference dimensions as in QT, division into sub-blocks may be performed on the basis of the PU.

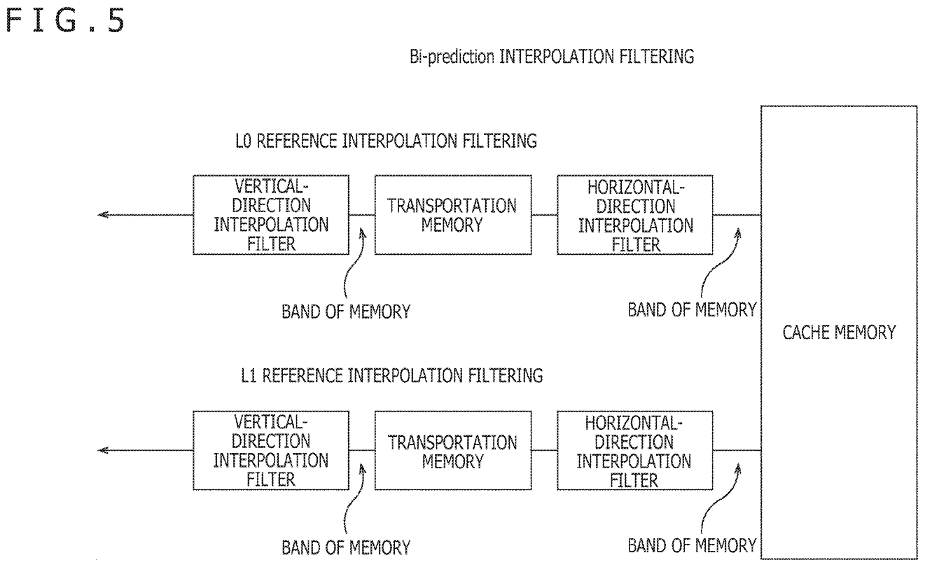

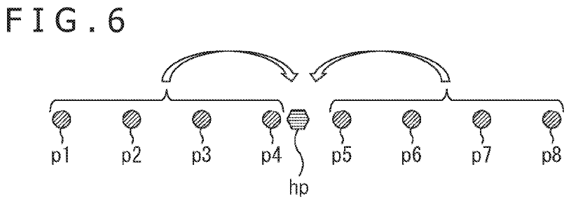

Next, an interpolation filter that is used to interpolate pixels during each of the inter-prediction processes at encoding circuit 23 and the decoding circuit 33 will be explained with reference to FIGS. 5 and 6.

As depicted in FIG. 5, in Bi-prediction interpolation filtering, L0 reference interpolation filtering and L1 reference interpolation filtering are parallelly performed.

For example, in L0 reference interpolation filtering, a horizontal-direction interpolation filter is adopted to a sub-block read out from a cache memory, the sub-block is stored into a transportation memory, the sub-block is read out from the transportation memory, a vertical-direction interpolation filter is adopted to the sub-block, and then, the sub-block is outputted. Also, in L1 reference interpolation filtering, processing similar to L0 reference interpolation filtering is performed.

Therefore, when reading out from the cache memory to the horizontal-direction interpolation filter is performed and when reading out from the transportation memory to the vertical-direction interpolation filter is performed, restrictions due to the band of the memory are imposed. In particular, in a case where a prediction direction of an inter-prediction process is Bi-prediction, the band of the memory needs to be wider so that the restrictions are more likely to be imposed.

Therefore, in a case where a prediction direction of an inter-prediction process is Bi-prediction, the encoding circuit 23 and the decoding circuit 33 each switch the tap length and use an interpolation having a short tap length, whereby restrictions due to the band of the memory can be avoided and reduction in the processing amount is expected.

Further, in a case where the tap length of an interpolation filter is shortened, each of the encoding circuit 23 and the decoding circuit 33 replaces the pixel values of pixels located outside a sub-block with the pixel values of nearby pixels, and can adopt the interpolation filter.

As depicted in FIG. 6, for example, the encoding circuit 23 and the decoding circuit 33 can perform a filtering process of generating a pixel hp from eight pixels p1 to p8, by using an interpolation filter having a tap length of 8 taps. Here, when shortening the tap length to 6 taps, each of the encoding circuit 23 and the decoding circuit 33 refrains from reading out the pixels p1 and p8, which are located outside, from the cache memory, but replaces the pixel values of the pixels p1 and p8 with the pixel values of the nearby pixels p2 and p7, and adopts the interpolation filter.

As a result of this filtering, the encoding circuit 23 and the decoding circuit 33 avoid restrictions imposed by the band of a memory so that the processing amounts of encoding and decoding can be reduced.

<Configuration Example of Image Encoding Device>

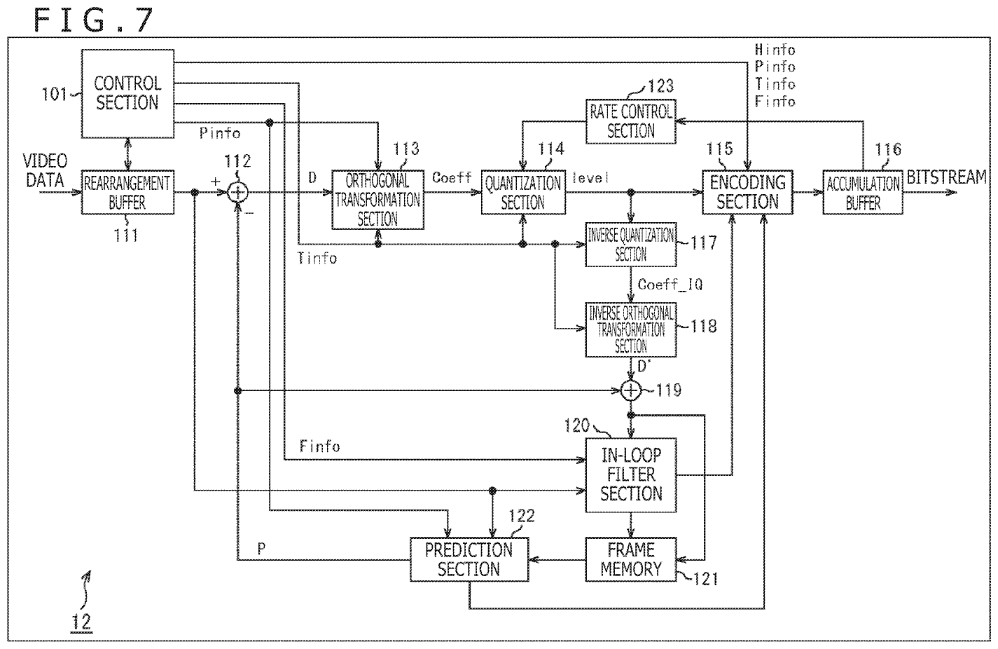

FIG. 7 is a block diagram depicting a configuration example of one embodiment of an image encoding device to which the present technique is applied.

The image encoding device 12 depicted in FIG. 7 encodes video image data. For example, the technique disclosed in NPL 1, NPL 2, or NPL 3 is installed into the image encoding device 12 so that the image encoding device 12 encodes video image data by a method conforming to the standard set forth in any one of those documents.

It is noted that FIG. 7 depicts the main processing sections and the main data flow, etc., and does not depict all of the processing sections and flows. That is, in the image encoding device 12, a processing section that is not depicted as a block in FIG. 7 or a process or data flow that is not depicted by an arrow or the like in FIG. 7 may be included.

As depicted in FIG. 7, the image encoding device 12 includes a control section 101, a rearrangement buffer 111, a computation section 112, an orthogonal transformation section 113, a quantization section 114, an encoding section 115, an accumulation buffer 116, an inverse quantization section 117, an inverse orthogonal transformation section 118, a computation section 119, an in-loop filter section 120, a frame memory 121, a prediction section 122, and a rate control section 123. It is to be noted that the prediction section 122 includes an intra prediction section and an inter-prediction section (not illustrated). The image encoding device 12 is a device for generating encoded data (a bitstream) by encoding video image data.

<Control Section>

The control section 101 divides video data held in the rearrangement buffer 111 into blocks (CU, PU, transformation blocks, or the like) which are units of processing on the basis of the block size of the outside or pre-designed unit of processing. Moreover, the control section 101 determines, on the basis of RDO (Rate-Distortion Optimization), for example, encoding parameters (header information Hinfo, prediction mode information Pinfo, transformation information Tinfo, filter information Finfo, etc.) to be supplied to the blocks.

These encoding parameters will be explained in detail later. After determining the above-mentioned encoding parameters, the control section 101 supplies the parameters to the blocks. Specifically, the control section 101 supplies the parameters, as follows.

The header information Hinfo is supplied to the blocks.

The prediction mode information Pinfo is supplied to the encoding section 115 and the prediction section 122.

The transformation information Tinfo is supplied to the encoding section 115, the orthogonal transformation section 113, the quantization section 114, the inverse quantization section 117, and the inverse orthogonal transformation section 118.

The filter information Finfo is supplied to the in-loop filter section 120.

Moreover, when setting a unit of processing, the control section 101 can set sub-block size identification information for identifying a sub-block size, in the manner previously explained with reference to FIG. 2. Then, the control section 101 also supplies the sub-block size identification information to the encoding section 115.

<Rearrangement Buffer>

The image encoding device 12 receives fields (input images) of video data in reproduction order (display order). The rearrangement buffer 111 acquires and holds (stores) the input images in the reproduction order (display order). Under control of the control section 101, the rearrangement buffer 111 rearranges the input images in encoding order (decoding order) or divides the input images into blocks each of which is a unit of processing. The rearrangement buffer 111 supplies the processed input images to the computation section 112. Moreover, the rearrangement buffer 111 also supplies to the input images (original images) to the prediction section 122 and the in-loop filter section 120.

<Computation Section>

The computation section 112 receives an image I that corresponds to a block which is a unit of processing, and a prediction image P supplied from the prediction section 122, subtracts the prediction image P from the image I, derives a prediction residual D (D=I−P), and supplies the prediction residual D to the orthogonal transformation section 113.

<Orthogonal Transformation Section>

The orthogonal transformation section 113 receives the prediction residual D supplied from the computation section 112 and the transformation information Tinfo supplied from the control section 101, performs orthogonal transformation on the prediction residual D on the basis of the transformation information Tinfo, and derives a transformation coefficient Coeff. The orthogonal transformation section 113 supplies the obtained transformation coefficient Coeff to the quantization section 114.

<Quantization Section>

The quantization section 114 receives the transformation coefficient Coeff supplied from the orthogonal transformation section 113 and the transformation information Tinfo supplied from the control section 101, and scales (quantizes) the transformation coefficient Coeff on the basis of the transformation information Tinfo. It is to be noted that the rate of this quantization is controlled by the rate control section 123. The quantization section 114 supplies the quantized transformation coefficient obtained through this quantization, that is, a quantization transformation coefficient level “level,” to the encoding section 115 and the inverse quantization section 117.

<Encoding Section>

The encoding section 115 receives the quantization transformation coefficient level “level” supplied from the quantization section 114, the various encoding parameters (header information Hinfo, prediction mode information Pinfo, transformation information Tinfo, filter information Finfo, etc.) supplied from the control section 101, filter-related information such as a filter coefficient supplied from the in-loop filter section 120, and optimum prediction mode-related information supplied from the prediction section 122. The encoding section 115 performs variable length encoding (e.g., arithmetic encoding) on the quantization transformation coefficient level “level” and generates a bit string (encoded data).

Also, the encoding section 115 derives residual information Rinfo from the quantization transformation coefficient level “level,” and generates a bit string by encoding the residual information Rinfo.

Furthermore, the encoding section 115 puts the filter-related information supplied from the in-loop filter section 120 into the filter information Finfo and puts the optimum prediction mode-related information supplied from the prediction section 122 into the prediction mode information Pinfo. Subsequently, the encoding section 115 encodes the above-mentioned various encoding parameters (header information Hinfo, prediction mode information Pinfo, transformation information Tinfo, filter information Finfo, etc.), and generates a bit string.

Also, the encoding section 115 multiplexes the bit strings of the information thus generated, thereby generates encoded data. The encoding section 115 supplies the encoded data to the accumulation buffer 116.

In addition, the encoding section 115 encodes the sub-block size identification information supplied from the control section 101, generates bit strings, and multiplexes the bit strings so that encoded data can be generated. Accordingly, the encoded data (bitstream) including the sub-block size identification information is transmitted, as previously explained with reference to FIG. 1.

<Accumulation Buffer>

The accumulation buffer 116 temporarily holds the encoded data obtained by the encoding section 115. The accumulation buffer 116 outputs the held encoded data in the form of, for example, a bitstream or the like to the outside of the image encoding device 12 at a predetermined timing. For example, the encoded data is transmitted to the decoding side via any recording medium, any transmission medium, any information processing device, or the like. That is, the accumulation buffer 116 also serves as a transmission section that transmits the encoded data (bitstream).

<Inverse Quantization Section>

The inverse quantization section 117 performs a process concerning inverse quantization. For example, the inverse quantization section 117 receives the quantization transformation coefficient level “level” supplied from the quantization section 114 and the transformation information Tinfo supplied from the control section 101, and scales (inversely quantizes) the value of the quantization transformation coefficient level “level” on the basis of the transformation information Tinfo. It is to be noted that this inverse quantization is an inverse process of the quantization performed at the quantization section 114. The inverse quantization section 117 supplies a transformation coefficient Coeff_IQ obtained by this inverse quantization to the inverse orthogonal transformation section 118.

<Inverse Orthogonal Transformation Section>

The inverse orthogonal transformation section 118 performs a process concerning inverse orthogonal transformation. For example, the inverse orthogonal transformation section 118 receives the transformation coefficient Coeff_IQ supplied from the inverse quantization section 117 and the transformation information Tinfo supplied from the control section 101, performs inverse orthogonal transformation on the transformation coefficient Coeff_IQ on the basis of the transformation information Tinfo, and derives a prediction residual D′. It is to be noted that this inverse orthogonal transformation is an inverse process of the orthogonal transformation performed at the orthogonal transformation section 113. The inverse orthogonal transformation section 118 supplies the prediction residual D′ obtained by this inverse orthogonal transformation to the computation section 119. It is to be noted that, since the inverse orthogonal transformation section 118 is similar to an inverse orthogonal transformation section (explained later) on the decoding side, an explanation (which will be given later) of the decoding side can be applied to the inverse orthogonal transformation section 118.

<Computation Section>

The computation section 119 receives the prediction residual D′ supplied from the inverse orthogonal transformation section 118 and the prediction image P supplied from the prediction section 122. The computation section 119 adds the prediction residual D′ and the prediction image P that corresponds to the prediction residual D′ and derives a locally decoded image R_{local} (R_{local}=D′+P). The computation section 119 supplies the locally decoded image R_{local} thus derived to the in-loop filter section 120 and the frame memory 121.

<In-loop Filter Section>

The in-loop filter section 120 performs a process concerning in-loop filtering. For example, the in-loop filter section 120 receives the locally decoded image R_{local} supplied from the computation section 119, the filter information Finfo supplied from the control section 101, and the input images (original images) supplied from the rearrangement buffer 111. It is to be noted that information which is inputted to the in-loop filter section 120 is optionally defined, and thus, any other information may be inputted. For example, information regarding a prediction mode, motion information, an encoding amount target value, a quantization parameter QP, a picture type, a block (CU, CTU etc.) or the like may be inputted to the in-loop filter section 120, as needed.

The in-loop filter section 120 performs filtering, as appropriate, on the locally decoded image R_{local} on the basis of the filter information Finfo. For the filtering, the in-loop filter section 120 uses the input images (original images) and any other inputted information, if needed.

For example, the in-loop filter section 120 adopts four in-loop filters which are a bilateral filter, a DeBlocking filter (DBF), an adaptive offset filter (SAO (Sample Adaptive Offset)), and an adaptive loop filter (ALF), in this order, as described in NPL 1. It is to be noted that which of the filters is adopted and the order of adopting the filters are optionally defined, and thus, can be selected, as appropriate.

It goes without saying that what filtering is performed by the in-loop filter section 120 is optionally defined, and thus, is not limited to the above-mentioned examples. For example, the in-loop filter section 120 may adopt a Wiener filter, etc.

The in-loop filter section 120 supplies the locally decoded image R_{local} having undergone the filtering to the frame memory 121. It is to be noted that, in a case where filter-related information such as a filter coefficient, for example, is to be transmitted to the decoding side, the in-loop filter section 120 supplies the filter-related information to the encoding section 115.

<Frame Memory>

The frame memory 121 performs a process concerning storing image data. For example, the frame memory 121 receives the locally decoded image R_{local} supplied from the computation section 119 and the locally decoded image R_{local} filtered and supplied from the in-loop filter section 120 and holds (stores) the locally decoded images R_{local}. Further, the frame memory 121 restructures a picture unit-based decoded image R by using the locally decoded images R_{local} and holds the decoded images R (stores the decoded images R into a buffer in the frame memory 121). In response to a request from the prediction section 122, the frame memory 121 supplies the decoded images R (or a part of the decoded images R) to the prediction section 122.

<Prediction Section>

The prediction section 122 performs a process concerning generation of a prediction image. For example, the prediction section 122 receives the prediction mode information Pinfo supplied from the control section 101, the input images (original images) supplied from the rearrangement buffer 111, and the decoded images R (or a part thereof) read out from the frame memory 121. The prediction section 122 performs a prediction process such as inter-prediction or intra prediction by using the prediction mode information Pinfo and the input images (original images), performs prediction by referring to the decoded images R as reference images, performs a motion compensation process on the basis of the prediction result, and generates a prediction image P. The prediction section 122 supplies the generated prediction image P to the computation section 112 and the computation section 119. Also, the prediction section 122 supplies information regarding the prediction mode selected through the above-mentioned process, that is, the optimum prediction mode to the encoding section 115, if needed.

Here, when performing such an inter-prediction process, the prediction section 122 can switch the sub-block size, as explained previously with reference to FIG. 2. Moreover, prediction section 122 can switch the tap length of the interpolation filter to interpolate pixels, as explained previously with reference to FIGS. 5 and 6. Then, when shortening the tap length of the interpolation filter, the prediction section 122 replaces the pixel value of a pixel located outside a sub-block with the pixel value of a near pixel, and then, adopts the interpolation filter.

<Rate Control Section>

The rate control section 123 performs a process concerning rate control. For example, in order to prevent occurrence of overflow or underflow, the rate control section 123 controls the rate of the quantizing operation of the quantization section 114 on the basis of the code amount of the encoded data accumulated in the accumulation buffer 116.

In the image encoding device 12 having the above-mentioned configuration, the control section 101 sets sub-block size identification information for identifying a sub-block size, and the encoding section 115 generates encoded data including the sub-block size identification information. In addition, the prediction section 122 switches the sub-block size, performs an inter-prediction process, and, during the inter-prediction process, switches the tap length of an interpolation filter and interpolates pixels. Therefore, the image encoding device 12 can reduce the processing amount of the inter-prediction process by using large sub-blocks or using an interpolation filter having a short tap length.

It is to be noted that processes which are performed by the setting section and the encoding section in the encoding circuit 23 as explained previously with reference to FIG. 2, may be performed by a plurality of blocks, for example, instead of being separately performed by each of the blocks depicted in FIG. 7.

<Configuration Example of Image Decoding Device>

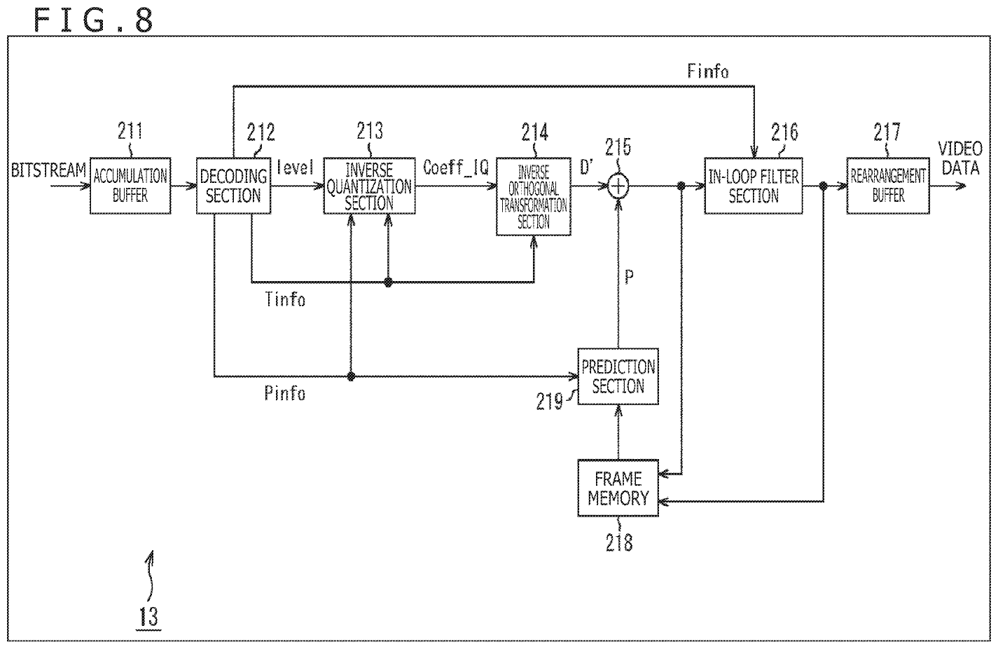

FIG. 8 is a block diagram depicting a configuration example of one embodiment of an image decoding device to which the present technique is applied. The image decoding device 13 depicted in FIG. 8 decodes encoded data that is obtained by encoding a prediction residual of an image and a corresponding prediction image as in AVC or HEVC. For example, the technique described in NPL 1, NPL 2, or NPL 3 is installed into the image decoding device 13 so that encoded data that is obtained by encoding video data is decoded by a method conforming to the standard described in any of these documents. For example, the image decoding device 13 decodes encoded data (bitstream) generated by the above-mentioned image encoding device 12.

It is to be noted that FIG. 8 depicts main processing sections and main flows, etc., and thus, FIG. 8 does not depict all the processing sections and flows. That is, in the image decoding device 13, a processing section that is not depicted as a block in FIG. 8 or a process or data flow that is not depicted by an arrow or the like in FIG. 8 may be included.

In FIG. 8, the image decoding device 13 includes an accumulation buffer 211, a decoding section 212, an inverse quantization section 213, an inverse orthogonal transformation section 214, a computation section 215, an in-loop filter section 216, a rearrangement buffer 217, a frame memory 218, and a prediction section 219. It is to be noted that the prediction section 219 includes an intra prediction section and an inter-prediction section (not illustrated). The image decoding device 13 is a device for generating video data by decoding encoded data (bitstream).

<Accumulation Buffer>

The accumulation buffer 211 acquires a bitstream inputted to the image decoding device 13, and holds (stores) the bitstream. At a predetermined timing or when a predetermined condition is established, for example, the accumulation buffer 211 supplies accumulated bitstreams to the decoding section 212.

<Decoding Section>

The decoding section 212 performs a process concerning image decoding. For example, the decoding section 212 receives the bitstream supplied from the accumulation buffer 211, performs variable length decoding of the syntax length of each syntax element from the bit string in accordance with a syntax table definition, and derives parameters.

For example, the syntax elements and the parameters derived from the syntax values of the syntax elements include header information Hinfo, prediction mode information Pinfo, transformation information Tinfo, residual information Rinfo, filter information Finfo, and the like. That is, the decoding section 212 parses (analyzes and acquires), from the bitstream, these kinds of the information. The information listed above will be explained below.

<Header Information Hinfo>

For example, the header information Hinfo includes header information such as VPS (Video Parameter Set)/SPS (Sequence Parameter Set)/PPS (Picture Parameter Set)/SH (slice header), etc. For example, the header information Hinfo includes information for defining a picture size (width PicWidth, height PicHeight), a bit depth (luminance bitDepthY, chroma bitDepthC), a chroma array type ChromaArrayType, a maximum value MaxCUSize/a minimum value MinCUSize of a CU size, a maximum depth MaxQTDepth/minimum depth MinQTDepth of Quad-tree division, a maximum depth MaxBTDepth/minimum depth MinBTDepth of Binary-tree division, a maximum value MaxTSSize of a transformation skip block (also referred to as maximum transformation skip block size), an on-off flag (also referred to as enabled flag) of each encoding tool, and the like.

Examples of an on-off flag of an encoding tool included in the header information Hinfo includes an on-off flag concerning a transformation and quantization process described below. It is to be noted that the on-off flag of the encoding tool can also be interpreted as a flag indicating whether or not a syntax concerning the encoding tool is included in the encoded data. In addition, in a case where the value of the on-off flag is 1 (true), use of the encoding tool is permitted. In a case where the value of the on-off flag is 0 (false), use of the encoding tool is prohibited. The flag values may be interpreted by contraries.

Cross-component prediction enabled flag (ccp_enabled_flag): flag information indicating whether or not use of cross-component prediction (also referred to as CCP (Cross-Component Prediction), CC prediction) is permitted. For example, in a case where this flag information is “1” (true), the use is permitted. In a case where this flag information is “0” (false), the use is prohibited.

It is to be noted that this CCP is also referred to as cross-component linear prediction (CCLM or CCLMP).

<Prediction Mode Information Pinfo>

For example, the prediction mode information Pinfo includes size information PBSize (prediction block size) of a process target PB (prediction block), intra prediction mode information IPinfo, movement prediction information MVinfo, and the like.

For example, the intra prediction mode information IPinfo includes prev_intra_luma_pred_flag, mpm_idx, and rem_intra_pred_mode in JCTVC-W1005, 7.3.8.5 Coding Unit syntax, and a luminance intra prediction mode IntraPredModeY derived from the syntax, etc.

Further, the intra prediction mode information IPinfo includes a cross-component prediction flag (ccp_flag (cclmp_flag)), a multi-class linear prediction mode flag (mclm_flag), a chroma sample location type identifier (chroma_sample_loc_type_idx), a chroma MPM identifier (chroma_mpm_idx), and a luminance intra prediction mode (IntraPredModeC) which is derived from these syntaxes, and the like, for example.

The cross-component prediction flag (ccp_flag (cclmp_flag)) is flag information indicating whether or not to adopt cross-component linear prediction. For example, when ccp_flag==1, cross-component linear prediction is adopted, and when ccp_flag==0, cross-component linear prediction is not adopted.

The multi-class linear prediction mode flag (mclm_flag) is information regarding a linear prediction mode (linear prediction mode information). More specifically, the multi-class linear prediction mode flag (mclm_flag) is flag information indicating whether or not to use a multi-class linear prediction mode. The flag “0” represents a 1-class mode (single class mode) (e.g. CCLMP), and the flag “1” represents a 2-class mode (multi-class mode) (e.g. MCLMP).

The chroma sample location type identifier (chroma_sample_loc_type_idx) is an identifier for identifying the pixel location type (also referred to as chroma sample location type) of a chroma component. For example, in a case where the chroma array type (ChromaArrayType) which is information regarding a color format indicates a 420 format, allocation for the chroma sample location type identifier is as follows.

chroma_sample_loc_type_idx==0: Type2

chroma_sample_loc_type_idx==1: Type3

chroma_sample_loc_type_idx==2: Type0

chroma_sample_loc_type_idx==3: Type1

It is to be noted the chroma sample location type identifier (chroma_sample_loc_type_idx) is transmitted as information (chroma_sample_loc_info( )) regarding a pixel location of a chroma component (while being included in the information).

The chroma MPM identifier (chroma_mpm_idx) indicates which prediction mode candidate is designated as a chroma intra prediction mode from a chroma intra prediction mode candidate list (intraPredModeCandListC).

For example, the movement prediction information MVinfo includes merge_idx, merge_flag, inter_pred_idc, ref_idx_LX, mvp_1X_flag, X={0,1}, mvd, etc. (for example, see JCTVC-W1005, 7.3.8.6 Prediction Unit Syntax).

It goes without saying that which information is included in the prediction mode information Pinfo is optionally defined, and thus, any other information may be included.

<Transformation Information Tinfo>

For example, the transformation information Tinfo includes information listed below. It goes without saying that which information is included in the transformation information Tinfo is optionally defined, and thus, any other information may be included.

Width size TBWSize and height TBHSize (or logarithmic values log 2TBWSize, log 2TBHSize of TBWSize and TBHSize to base 2) of a process target transformation block

Transformation skip flag (ts_flag): a flag indicating whether or not to skip an (inverse) primary transformation and an (inverse) secondary transformation

Scan identifier (scanIdx)

Quantization parameter (qp)

Quantization matrix (scaling_matrix (for example, JCTVC-W1005, 7.3.4 Scaling list data syntax))

<Residual Information Rinfo>

For example, the residual information Rinfo (for example, see JCTVC-W1005, 7.3.8.11 Residual Coding syntax) includes the following syntaxes.

cbf (coded_block_flag): a residual data presence/absence flag

last_sig_coeff_x_pos: a last non-zero coefficient X coordinate

last_sig_coeff_y_pos: a last non-zero coefficient Y coordinate

coded_sub_block_flag: a sub-block non-zero coefficient presence/absence flag

sig_coeff_flag: a non-zero coefficient presence/absence flag

gr1_flag: a flag indicating whether or not the level of a non-zero coefficient is greater than 1 (also called GR1_flag)

gr2 flag: a flag indicating whether or not the level of a non-zero coefficient is greater than 2 (also called GR2_flag)

sign_flag: a sign indicating whether or not a non-zero coefficient is positive or negative (also called sign code)

coeff_abs_level_remaining: a residual level of a non-zero coefficient (also called non-zero coefficient residual level), etc.

It goes without saying that which information is included in the residual information Rinfo is optionally defied, and thus, any other information may be included.

<Filter Information Finfo>

The filter information Finfo includes the following control information concerning filtering processes, for example.

Control information concerning a deblocking filter (DBF)

Control information concerning a pixel adaptive offset (SAO)

Control information concerning an adaptive loop filter (ALF)

Control information concerning another linear/non-linear filter

More specifically, the filter information Finfo includes information for designating a picture or a region in a picture to which each filter is to be applied, CU-based filter On/Off control information, filter On/Off control information concerning a boundary between slices and tiles, and the like, for example. It goes without saying that what information is included in the filter information Finfo is optionally defined, and thus, any other information may be included.

Returning to an explanation of the decoding section 212, the decoding section 212 derives the quantization transformation coefficient level “level” at each coefficient position in each transformation block by referring to the residual information Rinfo. The decoding section 212 supplies the quantization transformation coefficient level “level” to the inverse quantization section 213.

Further, the decoding section 212 supplies the parsed header information Hinfo, prediction mode information Pinfo, quantization transformation coefficient level “level,” transformation information Tinfo, and filter information Finfo to the blocks. Specifically, the information is supplied as follows.

The header information Hinfo is supplied to the inverse quantization section 213, the inverse orthogonal transformation section 214, the prediction section 219, and the in-loop filter section 216.

The prediction mode information Pinfo is supplied to the inverse quantization section 213 and the prediction section 219.

The transformation information Tinfo is supplied to the inverse quantization section 213 and the inverse orthogonal transformation section 214.

The filter information Finfo is supplied to the in-loop filter section 216.

It goes without saying that the above-mentioned example is one example and is not limitative. For example, the encoding parameters may be supplied to any processing section. In addition, any other information may be supplied to any processing section.

Moreover, in a case where sub-block size identification information for identifying a sub-block size is included in the bitstream, the decoding section 212 can parse the sub-block size identification information.

<Inverse Quantization Section>

The inverse quantization section 213 performs a process concerning inverse quantization. For example, the inverse quantization section 213 receives the transformation information Tinfo and the quantization transformation coefficient level “level” supplied from the decoding section 212, scales (inversely quantizes) the value of the quantization transformation coefficient level “level” on the basis of the transformation information Tinfo, and derives an inversely quantized transformation coefficient Coeff_IQ.

It is to be noted that this inverse quantization is performed as an inverse process of the quantization performed by the quantization section 114. Also, this inverse quantization is similar to the inverse quantization performed by the inverse quantization section 117. That is, the inverse quantization section 117 performs a process (inverse quantization) similar to that by the inverse quantization section 213.

The inverse quantization section 213 supplies the derived transformation coefficient Coeff_IQ to the inverse orthogonal transformation section 214.

<Inverse Orthogonal Transformation Section>

The inverse orthogonal transformation section 214 performs a process concerning inverse orthogonal transformation. For example, the inverse orthogonal transformation section 214 receives the transformation coefficient Coeff_IQ supplied from the inverse quantization section 213 and the transformation information Tinfo supplied from the decoding section 212, performs an inverse orthogonal transformation process on the transformation coefficient Coeff_IQ on the basis of the transformation information Tinfo, and derives a prediction residual D′.

It is to be noted that this inverse orthogonal transformation is performed as an inverse process of the orthogonal transformation performed by the orthogonal transformation section 113. In addition, this inverse orthogonal transformation is similar to the inverse orthogonal transformation performed by the inverse orthogonal transformation section 118. That is, the inverse orthogonal transformation section 118 performs a process (inverse orthogonal transformation) similar to that by the inverse orthogonal transformation section 214.

The inverse orthogonal transformation section 214 supplies the derived prediction residual D′ to the computation section 215.

<Computation Section>

The computation section 215 performs a process concerning addition of image-related information. For example, the computation section 215 receives the prediction residual D′ supplied from the inverse orthogonal transformation section 214 and the prediction image P supplied from the prediction section 219. The computation section 215 adds the prediction residual D′ and the prediction image P (prediction signal) that corresponds to the prediction residual D′ and derives a locally decoded image R_{local} (R_{local}=D′+P).

The computation section 215 supplies the locally decoded image R_{local} thus derived to the in-loop filter section 216 and the frame memory 218.

<In-Loop Filter Section>

The in-loop filter section 216 performs a process concerning in-loop filtering. For example, the in-loop filter section 216 receives the locally decoded image R_{local} supplied from the computation section 215 and the filter information Finfo supplied from the decoding section 212. It is to be noted that what information is inputted to the in-loop filter section 216 is optionally defined, and thus, any other information may be inputted.

The in-loop filter section 216 performs filtering on the locally decoded image R_{local} on the basis of the filter information Finfo, as appropriate.

For example, the in-loop filter section 216 adopts four in-loop filters which are a bilateral filter, a deblocking filter (DBF), an adaptive offset filter (SAO (Sample Adaptive Offset)), and an adaptive loop filter (ALF), in this order, as described in NPL 1. It is to be noted that which of the filters is adopted and the order of adopting the filters are optionally defined, and thus, can be selected, as appropriate.

The in-loop filter section 216 performs filtering that corresponds to the filtering performed by the encoding side (for example, the in-loop filter section 120 of the image encoding device 12 in FIG. 7).

It goes without saying that what filtering is performed by the in-loop filter section 216 is optionally defined, and thus, is not limited to the above-mentioned examples. For example, the in-loop filter section 216 may adopt a Wiener filter, etc.

The in-loop filter section 216 supplies the locally decoded image R_{local} having undergone the filtering to the rearrangement buffer 217 and the frame memory 218.

<Rearrangement Buffer>

The rearrangement buffer 217 receives the locally decoded image R_{local} supplied from the in-loop filter section 216 and holds (stores) the locally decoded image R_{local}. The rearrangement buffer 217 restructures a picture unit-based decoded image R by using the locally decoded images R_{local} and holds the decoded images R (in the buffer). The rearrangement buffer 217 rearranges, in reproduction order, the obtained decoded images R which are arranged in decoding order. The rearrangement buffer 217 outputs, as video data, the rearranged decoded images R to the outside of the image decoding device 13.

<Frame Memory>

The frame memory 218 performs a process concerning storage of image-related data. For example, the frame memory 218 receives the locally decoded image R_{local} supplied from the computation section 215, restructures a picture unit-based decoded image R, and stores the decoded image R in a buffer of the frame memory 218.

Further, the frame memory 218 receives the locally decoded image R_{local} having been in-loop filtered and supplied from the in-loop filter section 216, restructures a picture unit-based decoded image R, and stores the decoded image R in the frame memory 218. The frame memory 218 supplies, as reference images, the stored decoded image R (or a part thereof) to the prediction section 219, as appropriate.

It is to be noted that the frame memory 218 may store the header information Hinfo, the prediction mode information Pinfo, the transformation information Tinfo, the filter information Finfo, and the like, concerning generation of a decoded image.

<Prediction Section>

The prediction section 219 performs a process concerning generation of a prediction image. For example, the prediction section 219 receives the prediction mode information Pinfo supplied from the decoding section 212, performs prediction by a prediction method designated by the prediction mode information Pinfo, and derives a prediction image P. In this deriving, the prediction section 219 uses, as reference images, unfiltered or filtered decoded images R (or a part thereof) which are stored in the frame memory 218 and designated by the prediction mode information Pinfo. The prediction section 219 supplies the derived prediction image P to the computation section 215.

Here, when performing an inter-prediction process, the prediction section 219 can switch a sub-block size in accordance with the sub-block size identification information parsed from the bitstream by the decoding section 212, as previously explained with reference to FIG. 3. Moreover, the prediction section 219 can switch the tap length of an interpolation filter to interpolate pixels, as previously explained with reference to FIGS. 5 and 6. Then, in a case where the tap length of the interpolation filter is shortened, the prediction section 219 replaces the pixel value of a pixel located outside the sub-block with the pixel value of a nearby pixel, and adopts the interpolation filter.

In the image decoding device 13 having the above-mentioned configuration, the decoding section 212 performs a parse process of parsing sub-block size identification information from a bitstream. In addition, the prediction section 219 switches the sub-block size in accordance with the sub-block size identification information and performs an inter-prediction process. During the inter-prediction process, the prediction section 219 interpolates pixels by switching the tap length of the interpolation filter. Therefore, the image decoding device 13 uses a large sub-block or by using an interpolation filter having a short tap length so that the processing amount of the inter-prediction process can be reduced.

It is to be noted that the processes which are performed by the parse section and the decoding section in the decoding circuit 33 explained previously with reference to FIG. 3, may be performed by a plurality of blocks, for example, instead of being separately performed by the blocks depicted in FIG. 8.

<Image Encoding Process and Image Decoding Process>

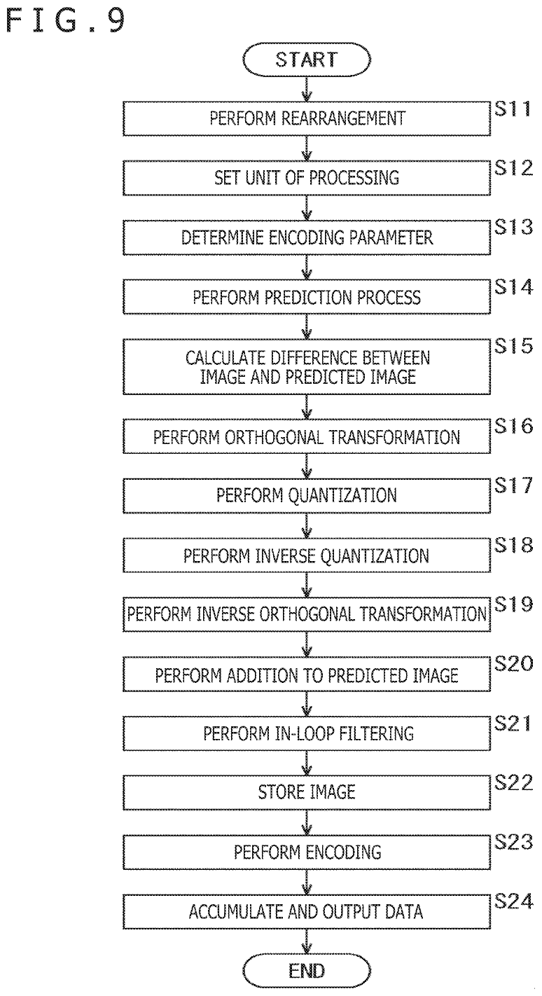

Image encoding which is executed by the image encoding device 12 and image decoding which is executed by the image decoding device 13 will be explained with reference to the flowcharts in FIGS. 9 to 14.

FIG. 9 is a flowchart for explaining an image encoding process which is executed by the image encoding device 12.

When the image encoding process is started, the rearrangement buffer 111 rearranges, in encoding order, the order of frames of inputted video data which are arranged in display order, at step S11 under control of the control section 101.

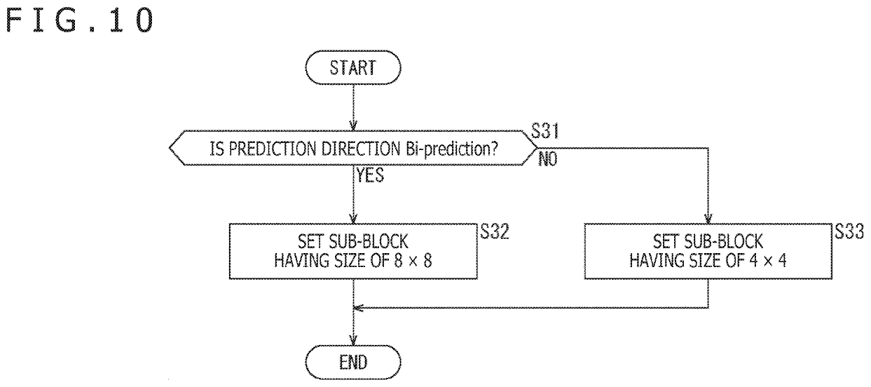

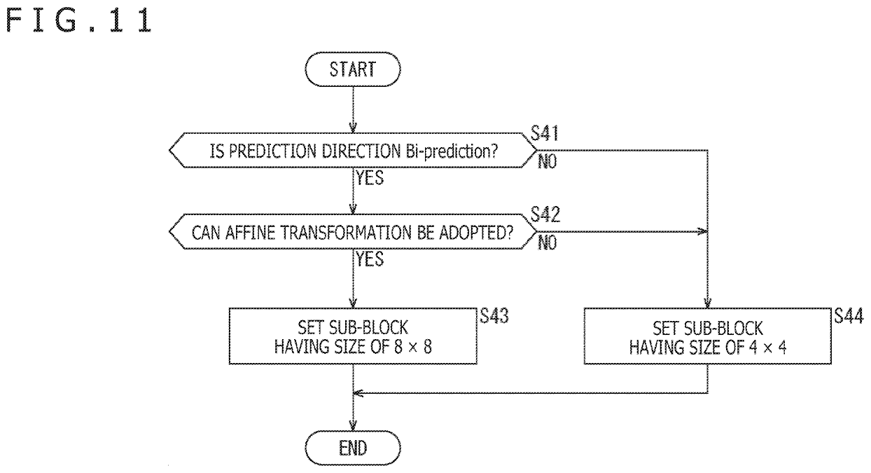

At step S12, the control section 101 sets a unit of processing for input images (divides the input images into blocks) held by the rearrangement buffer 111. Here, when setting a unit of processing, a process of setting sub-block size identification information, which will be explained later with reference to FIGS. 10 and 11, is also performed.

At step S13, the control section 101 determines (sets) encoding parameters for the input images held by the rearrangement buffer 111.

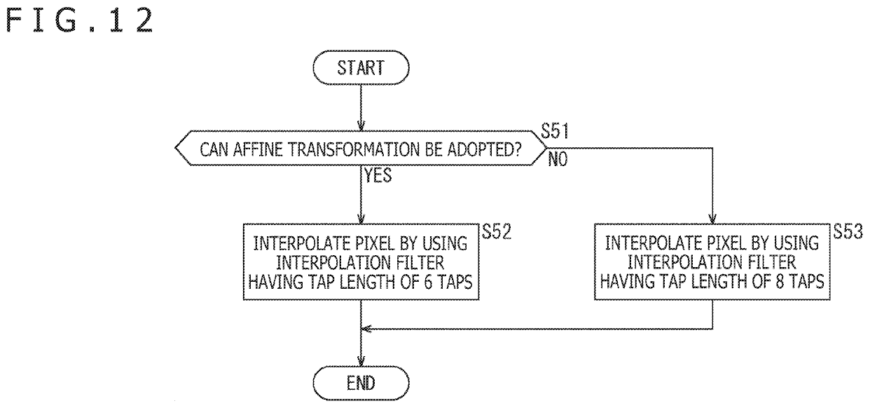

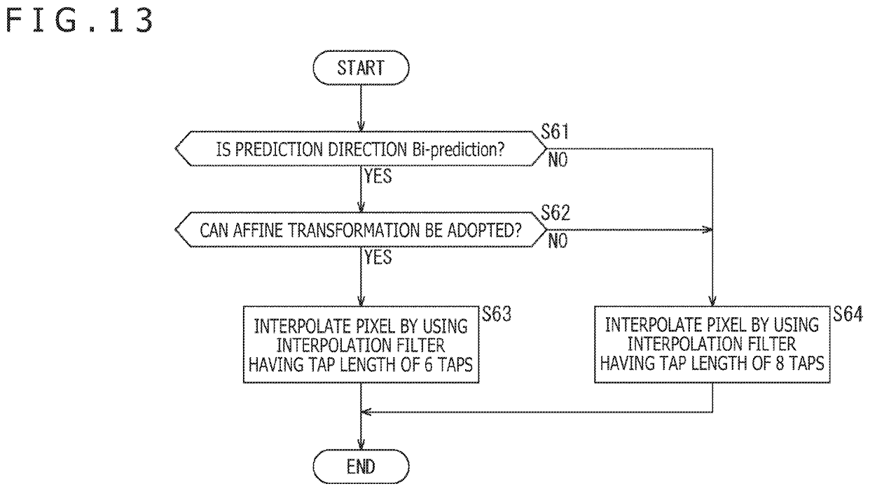

At step S14, the prediction section 122 performs a prediction process to generate a prediction image or the like of an optimum prediction mode. For example, in the prediction process, the prediction section 122 generates a prediction image or the like of an optimum intra prediction mode by performing intra prediction, generates a prediction image or the like of an optimum inter-prediction mode by performing inter-prediction, and selects an optimum prediction mode of these modes on the basis of a cost function value or the like. When the prediction process is performed, the size of a sub-block to be used in the inter-prediction process can be switched, as previously described with reference to FIG. 2. Furthermore, in the prediction process, a process of switching the tap length of an interpolation filter and interpolating pixels is performed, as explained later with reference to FIGS. 12 and 13.

At step S15, the computation section 112 computes the difference between the input image and the prediction image of the optimum mode selected by the prediction process at step S14. That is, the computation section 112 generates a prediction residual D of the input image and the prediction image. The data amount of the prediction residual D thus obtained is smaller than that of the original image data. Therefore, the data amount can be further compressed, compared to a case of directly encoding an image.

At step S16, the orthogonal transformation section 113 performs orthogonal transformation on the prediction residual D generated at step S15 and derives a transformation coefficient Coeff.

At step S17, the quantization section 114 quantizes the transformation coefficient Coeff obtained at step S16 by using, for example, a quantization parameter calculated by the control section 101, and derives a quantization transformation coefficient level “level.”

At step S18, the inverse quantization section 117 inversely quantizes the quantization transformation coefficient level “level.” generated at step S17, on the basis of characteristics corresponding to the characteristics of the quantization at step S17, and derives a transformation coefficient Coeff_IQ.

At step S19, the inverse orthogonal transformation section 118 performs inverse orthogonal transformation on the transformation coefficient Coeff_IQ obtained at step S18, by a method corresponding to the orthogonal transformation performed at step S16, thereby derives a prediction residual D′. It is to be noted that this inverse orthogonal transformation is similar to inverse orthogonal transformation (which will be explained later) to be performed on the decoding side. Thus, an explanation (which will be given later) of the decoding side can apply to the inverse orthogonal transformation at step S19.

At step S20, the computation section 119 adds the prediction image obtained through the prediction process at step S14, to the prediction residual D′ derived at step S19, thereby generates a decoded image which has been locally decoded.

At step S21, the in-loop filter section 120 performs in-loop filtering on the decoded image which has been locally decoded and derived at step S20.

At step S22, the frame memory 121 stores the decoded image which has been locally decoded and derived at step S20, and the decoded image which has been locally decoded and filtered at step S21.

At step S23, the encoding section 115 encodes the quantization transformation coefficient level “level” obtained at step S17. For example, the encoding section 115 encodes the quantization transformation coefficient level “level,” which is image-related information, by arithmetic encoding or the like, and generates encoded data. Also, in this step, the encoding section 115 encodes various encoding parameters (header information Hinfo, prediction mode information Pinfo, transformation information Tinfo). Furthermore, the encoding section 115 derives the residual information RInfo from the quantization transformation coefficient level “level,” and encodes the residual information RInfo.

At step S24, the accumulation buffer 116 accumulates the encoded data obtained in the above manner, and outputs the encoded data, in the form of, for example, a bitstream, to the outside of the image encoding device 12. The bitstream is transmitted to the decoding side via a transmission path or a recording medium, for example. In addition, the rate control section 123 performs rate control, if needed.

When step S24 is completed, the image encoding is ended.

In the image encoding process having the above-mentioned flow, the above-mentioned processes to which the present technique is applied are performed as step S12 and step S14. Therefore, as a result of execution of this image encoding process, the processing amount of the inter-prediction process can be used by use of large sub-blocks and by use of an interpolation filter having a short tap length.

FIG. 10 is a flowchart for explaining a first processing example of setting the sub-block size identification information at step S12 in FIG. 9.

At step S31, the control section 101 determines whether or not a prediction direction of an inter-prediction process is Bi-prediction.

In a case where the control section 101 determines at step S31 that the prediction direction of the inter-prediction process is Bi-prediction, the process proceeds to step S32. Then, at step S32, the control section 101 sets sub-block size identification information to use a sub-block having a size of 8×8. Thereafter, the process is ended.

On the other hand, in a case where the control section 101 determines at step S31 that the prediction direction of the inter-prediction process is no Bi-prediction, the process proceeds to step S33. Then, at step S33, the control section 101 sets the sub-block size identification information to use a sub-block having a size of 4×4. Thereafter, the process is ended.

As explained so far, in a case where the prediction direction of the in the inter-prediction process is Bi-prediction, the control section 101 can set the sub-block size identification information to set a sub-block size to be large.

FIG. 11 is a flowchart for explaining a second processing example of setting the sub-block size identification information at step S12 in FIG. 9.

At step S41, the control section 101 determines whether or not a prediction direction of an inter-prediction process is Bi-prediction.

In a case where the control section 101 determines at step S41 that the prediction direction of the inter-prediction process is Bi-prediction, the process proceeds to step S42. At step S42, the control section 101 determines whether or not to adopt an affine transformation as the inter-prediction process.

In a case where the control section 101 determines at step S42 that an affine transformation is to be adopted as the inter-prediction process, the process proceeds to step S43. Then, at step S43, the control section 101 sets the sub-block size identification information to use a sub-block having a size of 8×8. Thereafter, the process is ended.

On the other hand, in a case where the control section 101 determines at step S41 that the prediction direction of the inter-prediction process is not Bi-prediction, or in a case where a determination that an affine transformation is not to be adopted as the inter-prediction process is made at step S42, the process proceeds to step S44. Then, at step S44, the control section 101 sets the sub-block size identification information to use a sub-block having a size of 4×4. Thereafter, the process is ended.

As explained so far, in a case where the prediction direction of the inter-prediction process is Bi-prediction and an affine transformation is adopted as the inter-prediction process, the control section 101 can set the sub-block size identification information to set a sub-block size to be large.

It is to be noted that, during the prediction process at step S14, the prediction section 122 can switch the size of a sub-block to be used in the inter-prediction process, by performing similar to that in FIG. 10 or 11.

FIG. 12 is a flowchart for explaining a first processing example of switching the tap length of an interpolation filter to be used in the prediction process, which is performed at step S14 in FIG. 9.

At step S51, the prediction section 122 determines whether or not an affine transformation is to be adopted as the inter-prediction process.

In a case where the prediction section 122 determines at step S51 that an affine transformation is to be adopted as the inter-prediction process, the process proceeds to step S52. Then, at step S52, the prediction section 122 interpolates pixels by using an interpolation filter having a tap length of 6 taps. Thereafter, the process is ended.

On the other hand, in a case where the prediction section 122 determines at step S51 that an affine transformation is not to be adopted in the inter-prediction process, the process proceeds to step S53. In this case, for example, a parallel translation is used in the inter-prediction process, and the prediction section 122 interpolates pixels by using an interpolation filter having a tap length of 8 taps at step S53. Thereafter, the process is ended.

As explained so far, in a case where an affine transformation is adopted in the inter-prediction process, the prediction section 122 can interpolate pixels by using an interpolation having a short tap length.

FIG. 13 is a flowchart for explaining a second processing example of switching the tap length of an interpolation filter to be used in the prediction process, which is performed at step S14 in FIG. 9.

At step S61, the prediction section 122 determines whether or not a prediction direction of an inter-prediction process is Bi-prediction.

In a case where the prediction section 122 determines at step S61 that the prediction direction of the inter-prediction process is Bi-prediction, the process proceeds to step S62. At step S62, the prediction section 122 determines whether or not an affine transformation is to be adopted as the inter-prediction process.

In a case where the prediction section 122 determines at step S62 that an affine transformation is to be adopted as the inter-prediction process, the process proceeds to step S63. Then, at step S63, the prediction section 122 interpolates pixels by using an interpolation filter having a tap length of 6 taps. Thereafter, the process is ended.

On the other hand, in a case where the prediction section 122 determines at step S61 that the prediction direction of the inter-prediction process is not Bi-prediction, or in a case where the prediction section 122 determines at step S62 that an affine transformation is not to be adopted as the inter-prediction process, the process proceeds to step S64. In this case, for example, a parallel translation is used in the inter-prediction process, and the prediction section 122 interpolates pixels by using an interpolation filter having a tap length of 8 taps at step S64. Thereafter, the process is ended.

As explained so far, in a case where a prediction direction of an inter-prediction process is Bi-prediction and an affine transformation is adopted as the inter-prediction process, the prediction section 122 can interpolate pixels by using an interpolation having a short tap length.

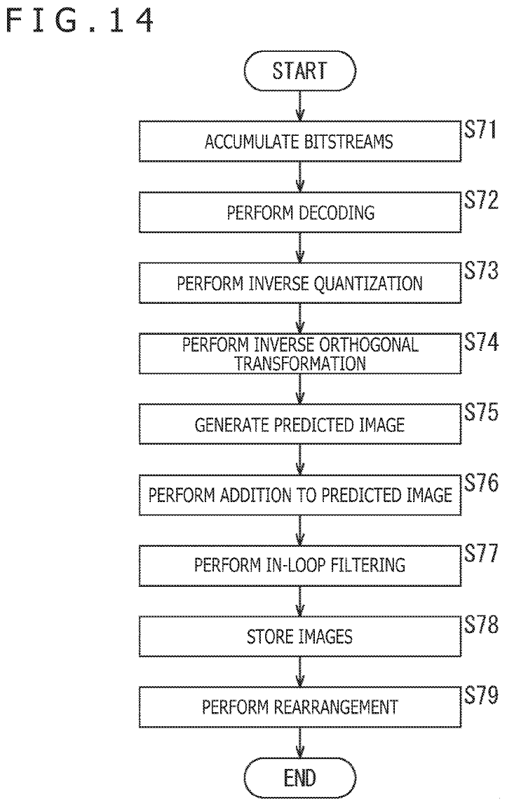

FIG. 14 is a flowchart for explaining an image decoding process which is executed by the image decoding device 13.

When the image decoding is started, the accumulation buffer 211 acquires and holds (accumulates), at step S71, encoded data (bitstream) supplied from the outside of the image decoding device 13.

At step S72, the decoding section 212 decodes the encoded data (bitstream) and obtains a quantization transformation coefficient level “level.” In addition, through this decoding, the decoding section 212 parses various encoding parameters from the encoded data (bitstream). When this decoding process is performed, a process of parsing sub-block size identification information from the bitstream is also performed, as explained previously with reference to FIG. 3.

At step S73, the inverse quantization section 213 performs, on the quantization transformation coefficient level “level” obtained at step S72, inverse quantization which is an inverse process of the quantization performed at the encoding side, and obtains a transformation coefficient Coeff_IQ.

At step S74, the inverse orthogonal transformation section 214 performs, on the transformation coefficient Coeff_IQ obtained at step S73, inverse orthogonal transformation which is an inverse process of the orthogonal transformation performed on the encoding side, and obtains a prediction residual D′.

At step S75, the prediction section 219 performs a prediction process on the basis of the information parsed at step S72 and by a prediction method designated by the encoding side, and generates a prediction image P by, for example, referring to a reference image stored in the frame memory 218. Here, to perform the prediction process, the size of a sub-block to be used in the inter-prediction process can be switched, as previously explained with reference to FIG. 3. Moreover, in the prediction process, a process of switching the tap length of an interpolation filter and complementing pixels is also performed, similar to the process previously explained with reference to FIGS. 12 and 13.

At step S76, the computation section 215 adds the prediction residual D′ obtained at step S74 and the prediction image P obtained at step S75 and derives a locally decoded image R_{local}.

At step S77, the in-loop filter section 216 performs in-loop filtering on the locally decoded image R_{local} obtained at step S76.

At step S78, the rearrangement buffer 217 derives decoded images R by using the locally decoded images R_{local} filtered and obtained at step S77 and rearranges the order of a group of the decoded images R from the decoding order to a reproduction order. The group of the decoded images R rearranged in the reproduction order is outputted, as a video, to the outside of the image decoding device 13.

Further, at step S79, the frame memory 218 records at least one of the locally decoded image R_{local} obtained at step S76 or the locally decoded image R_{local} filtered and obtained by step S77.

When step S79 is completed, the image decoding is ended.

In the image decoding process having the above-mentioned flow, processes to which the above-mentioned present technique is applied are performed as step S72 and step S75. Therefore, as a result of execution of this image decoding process, the processing amount of the inter-prediction process can be reduced with use of large sub-blocks and with use of an interpolation filter having a short tap length.

It is to be noted that the above-mentioned processing regarding an interpolation filter may be applied to an AIF (Adaptive Interpolation Filter), for example.

<Configuration Example of Computer>

Next, the above-mentioned series of processes can be implemented by hardware and also can be implemented by software. In a case where the series of processes is implemented by software, a program constituting the software is installed into a general-purpose computer or the like.

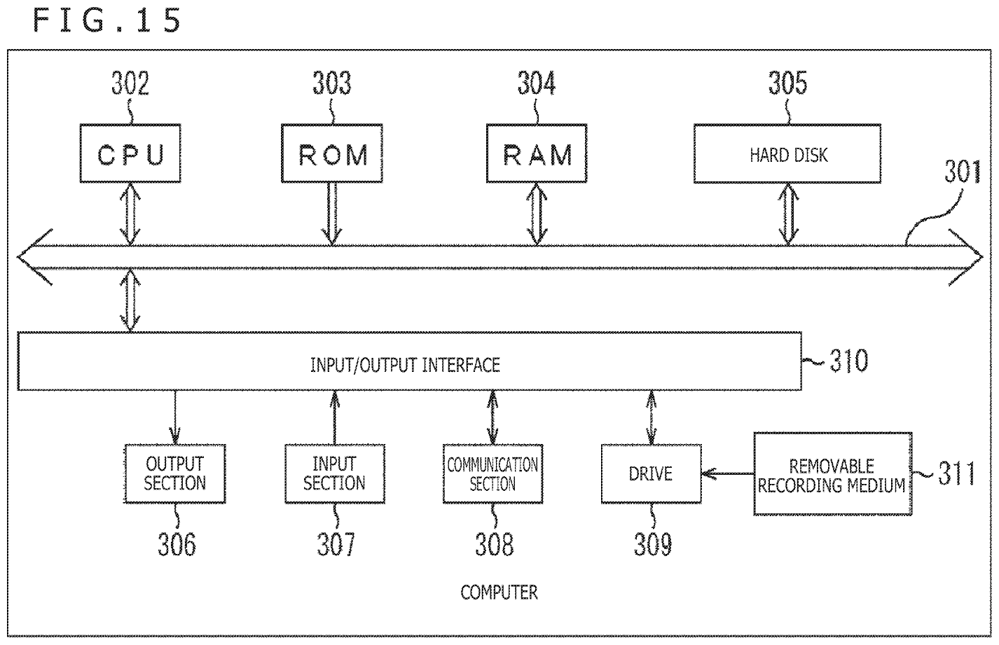

FIG. 15 is a block diagram depicting a configuration example of one embodiment of a computer into which the program for implementing the above-mentioned series of processes is installed.

The program can be previously recorded in a ROM 303 or a hard disk 305 serving as a recording medium incorporated in the computer.

Alternatively, the program can be stored (recorded) in a removable recording medium 311 that is driven by a drive 309. The removable recording medium 311 can be provided as what is called a package software. Here, for example, a flexible disc, a CD-ROM (Compact Disc Read Only Memory), an MO (Magneto Optical) disc, a DVD (Digital Versatile Disc), a magnetic disc, a semiconductor memory, or the like, can be used as the removable recording medium 311.

It is to be noted that not the program can be installed from the above-mentioned removable recording medium 311 into the computer, or the program can be downloaded to the computer over a communication network or a broadcasting network, and be installed into the incorporated hard disk 305. That is, the program can be wirelessly transferred from a download site to the computer over an artificial satellite for a digital satellite broadcast, or can be transferred to the computer by wire over a network such as a LAN (Local Area Network) or the internet.

A CPU (Central Processing Unit) 302 is incorporated in the computer, and an input/output interface 310 is connected to the CPU 302 via a bus 301.

When an input section 307 is, for example, operated by a user to input a command to the CPU 302 via the input/output interface 310, the CPU 302 executes the program stored in the ROM (Read Only Memory) 303 in accordance with the command. Alternatively, the CPU 302 loads the program stored in the hard disk 305 to a RAM (Random Access Memory) 304 and executes the program.

As a result of this, the CPU 302 performs processing according to the above-mentioned flowcharts, or processing by the above-mentioned configurations in the block diagrams. Then, if needed, the CPU 302 outputs the processing result from an output section 306 via the input/output interface 310, or transmits the processing result from a communication section 308 and causes the hard disk 305 to record the result, for example.

It is to be noted the input section 307 includes a keyboard, a mousse, a microphone, or the like. Also, the output section 306 includes an LCD (Liquid Crystal Display), a loudspeaker, or the like.

Here, in the present specification, processing which is performed by the computer in accordance with the program does not need to be performed in time series as described in any of the flowcharts. That is, processing which is performed by the computer in accordance with the program includes processes (e.g., parallel processes, or processes by an object) that are parallelly or separately executed.

Further, the program may be executed by a single computer (processor) or may be distributedly executed by a plurality of computers. In addition, the program may be transferred to a remote computer, and be executed there.

Moreover, the term “system” in the present specification means a set of multiple constituent components (devices, modules (components), etc.), whether or not all the constituent components are included in the same casing does not matter. Therefore, a set of multiple devices that are housed in different casings and are connected over a network is a system, and further, a single device having multiple modules housed in a single casing is also a system.

In addition, a single device (or processing section) in the above explanation may be divided into a plurality of devices (or processing sections). In contrast, a plurality of devices (or processing sections) in the above explanation may be integrated together into a single device (or processing section). Also, any configuration other than those explained above may be added to the configuration of each of the devices (or processing sections). Furthermore, a part of a device (or processing section) may be included in the configuration of another device (or another processing section), as long as the configuration or operation of the entire system substantially is unchanged.

Furthermore, for example, the present technique can have a cloud computing form of sharing and processing one function cooperatively by a plurality of devices over a network.

Moreover, for example, the above-mentioned program can be executed in any device. In this case, it is sufficient that the device has a necessary function (functional block, etc.) to become capable of obtaining necessary information.

Furthermore, for example, the steps explained in the above-mentioned flowcharts can be performed by a single device or can also be performed cooperatively by a plurality of devices. Also, in a case where a plurality of processes is included in one step, the plurality of processes included in the one step can be executed by a single device, or can also be performed cooperatively by a plurality of devices. In other words, a plurality of processes included in one step can be executed at a plurality of steps. On the contrary, processes explained as a plurality of steps can be combined together and executed as one step.

It is to be noted that the program which is executed by the computer may set so as to execute steps for writing the program in the time-series order explained herein, or may be set so as to execute the processes separately at respective necessary timings such as a timing at which a call is made. That is, the program may be set so as to execute the steps in an order different from the above-mentioned order as long as there is no inconsistency. Moreover, the steps for writing the program may be executed in parallel with processes of another program or may be executed in combination with processes of another program.

It is to be noted that a plurality of aspects of the present technique explained herein can be implemented independently and singly implemented as long as there is no inconsistency. It goes without saying that any optional aspects of the present technique can be implemented in combination. For example, a part or the entirety of the present technique explained in any one of the embodiments can be implemented in combination with a part or the entirety of the present technique explained in another one of the embodiments. In addition, any part or the entirety of the above-mentioned present technique can be implemented in combination with another technique which has not been explained previously.

<Application Targets of Present Technique>

The present technique is applicable to any image encoding/decoding scheme. That is, as long as there is no inconsistency with the above-mentioned present technique, processing specifications concerning image encoding and decoding such as transformation (inverse transformation), quantization (inverse quantization), encoding (decoding), and prediction, are optionally defined. The processing specifications are not limited to those in the above-mentioned examples. In addition, a part of the processing may be omitted as long as there is no inconsistency with the above-mentioned present technique.

Furthermore, the present technique is applicable to a multi-viewpoint image encoding/decoding system for encoding/decoding multiple-viewpoint images that include images taken from multiple viewpoints (views). In this case, it is sufficient to apply the present technique to encoding/decoding for the viewpoints (views).

Moreover, the present technique is applicable to a hierarchical encoding (scalable encoding)/decoding system for encoding/decoding hierarchical images that are layered (hierarchized) so as to provide a scalability function with respect to a predetermined parameter. In this case, it is sufficient to apply the present technique to encoding/decoding of each level (layer) of the hierarchy.

The image encoding device and the image decoding device according to the embodiments, can be applied to various electronic apparatuses such as a transmitter and a receiver (e.g. a television receiver, a mobile phone) for wired broadcasting such as satellite broadcasting or cable television, for distribution over the internet, or for distribution to terminals through cellular communication, or an apparatus (e.g. a hard disk recorder, a camera) for recording images into media such as optical disks, magnetic disks, and flash memories and reproducing the images from these recording media.

Furthermore, the present technique can be implemented as any configuration that is mounted on a device constituting any apparatus or system, for example, a processor (e.g. video processor) serving as a system LSI (Large Scale Integration) or the like, a module (e.g. video module) that uses a plurality of processors or the like, a unit (e.g. video unit) that uses a plurality of modules or the like, a set (e.g. video set) obtained by adding any other functions to a unit or the like (that is, can be implemented as a part of a device).

Moreover, the present technique is also applicable to a network system including a plurality of devices. For example, the present technique is also applicable to a cloud service for providing image (video)-related services to any terminals such as computers, AV (Audio Visual) devices, portable information processing terminals, and IoT (Internet of Things) devices.

It is to be noted that a system, a device, a processing section, etc., to which the present technique is applied, can be used in any field such as transportation, medical care, crime prevention, agriculture, livestock industry, mining industry, cosmetology, factories, household electronics, or weather or nature monitoring, for example. In addition, application thereof is also optionally defined.

For example, the present technique is applicable to a system or device that is used to provide content for appreciation or the like. Also, for example, the present technique is applicable to a traffic system or device that is used to monitor a traffic condition, to control automatic driving, or the like. In addition, for example, the present technique is applicable to a system or device for security. In addition, for example, the present technique is applicable to a system or device that is used to automatically control machines and the like. In addition, for example, the present technique is applicable to a system or device that is used for the agriculture or livestock industry. In addition, for example, the present technique is applicable to a system or device that monitors the conditions of nature such as volcanoes, woods, or oceans, or monitors wildlife, etc. In addition, for example, the present technique is also applicable to a system or device that is used for sports.

<Examples of Combining Configurations>

It is to be noted that the present technique also may have the following configurations.

(1)

An image encoding device including:

a setting section that sets identification information for identifying a sub-block size which represents a size of a sub-block to be used in an inter-prediction process of an image; and

an encoding section that performs switching to the sub-block having the size set by the setting section, encodes the image by performing the inter-prediction process, and generates a bitstream including the identification information.

(2)

The image encoding device according to (1), in which

the encoding section performs the inter-prediction process by adopting an affine transformation to the sub-block.

(3)

The image encoding device according to (1), in which

the encoding section performs the inter-prediction process by adopting FRUC (Frame Rate Up Conversion) to the sub-block.

(4)

The image encoding device according to any one of (1) to (3), in which

in a case where a processing amount required for an application that encodes the image or decodes the bitstream is equal to or less than a predetermined set value, the setting section sets the identification information such that the sub-block size is large.

(5)

The image encoding device according to any one of (1) to (4), in which

the setting section switches the sub-block size in accordance with a prediction direction of the inter-prediction process.

(6)

The image encoding device according to (5), in which

in a case where the prediction direction of the inter-prediction process is Bi-prediction, the setting section sets the identification information such that the sub-block size is large.

(7)

The image encoding device according to (5), in which

the setting section sets the identification information such that the sub-block size varies in accordance with whether or not the prediction direction of the inter-prediction process is Bi-prediction.

(8)

The image encoding device according to any one of (1) to (7), in which

in a case where an affine transformation is adopted as the inter-prediction process, the encoding section interpolates a pixel in the inter-prediction process by using an interpolation filter having a shortened tap length.

(9)

The image encoding device according to (8), in which

the encoding section switches the interpolation filter such that the tap length of the interpolation filter that is used in a case where the affine transformation is adopted as the inter-prediction process differs from the tap length of the interpolation filter that is used in a case where a prediction process other than the affine transformation is adopted as the inter-prediction process.

(10)

The image encoding device according to (9), in which

the encoding section switches the interpolation filter such that the tap length of the interpolation filter that is used in a case where the affine transformation is adopted as the inter-prediction process is 6 taps, and the tap length of the interpolation filter that is used in a case where a prediction process other than the affine transformation is adopted as the inter-prediction process is 8 taps.

(11)

The image encoding device according to any one of (1) to (10), in which

in a case where an affine transformation is adopted as the inter-prediction process and a prediction direction of the inter-prediction process is Bi-prediction, the encoding section switches the sub-block size, and performs the inter-prediction process.

(12)

The image encoding device according to any one of (1) to (11), in which

in a case where an affine transformation is adopted as the inter-prediction process and a prediction direction of the inter-prediction process is Bi-prediction, the encoding section performs the inter-prediction process by using the sub-block the sub-block size of which is large.

(13)

The image encoding device according to any one of (1) to (12), in which

in a case where an affine transformation is adopted as the inter-prediction process and a prediction direction of the inter-prediction process is Bi-prediction, the encoding section switches the number of taps of an interpolation filter which is used to interpolate a pixel in the inter-prediction process.

(14)

The image encoding device according to (13), in which

in a case where an affine transformation is adopted as the inter-prediction process and a prediction direction of the inter-prediction process is Bi-prediction, the encoding section interpolates the pixel in the inter-prediction process by using the interpolation filter having a shortened tap length.

(15)

The image encoding device according to (14), in which

the encoding section adopts the interpolation filter by substituting, for a pixel value of a pixel located outside an image of the sub-block, a pixel value of a nearby pixel.

(16)

The image encoding device according to (15), in which

the encoding section adopts the interpolation filter by using an image from which the pixel outside the sub-block has been excluded.

(17)

An image encoding method including:

causing an image encoding device, which encodes an image, to set identification information for identifying a sub-block size which represents a size of a sub-block to be used in an inter-prediction process of the image; and

causing the image encoding device to perform switching to the sub-block having the size according to the setting, encode the image by performing the inter-prediction process, and generate a bitstream including the identification information.

(18)

An image decoding device including:

a parse section that parses identification information for identifying a sub-block size, from a bitstream including the identification information, the sub-block size representing a size of a sub-block to be used in an inter-prediction process of an image; and

a decoding section that performs switching to the sub-block having the size according to the identification information parsed by the parse section, performs the inter-prediction process to decode the bitstream, and generates the image.

(19)

An image decoding method including:

causing an image decoding device, which decodes an image, to parse identification information for identifying a sub-block size, from a bitstream including the identification information, the sub-block size representing a size of a sub-block to be used in an inter-prediction process of the image; and

causing the image decoding device to perform switching to the sub-block having the size according to the parsed identification information, perform the inter-prediction process to decode the bitstream, and generate the image.

It is to be noted that the embodiments of the present technique are not limited to the above-mentioned embodiments, and various modifications can be made within the scope of the gist of the present disclosure. In addition, the effect described in the present specification is just examples and are not limited. Thus, any other effect may be provided.

### REFERENCE SIGNS LIST

11 Image processing system, 12 Image encoding device, 13 Image decoding device, 21 Image processing chip, 22 External memory, 23 Encoding circuit, 24 Cache memory, 31 Image processing chip, 32 External memory, 33 Decoding circuit, 34 Cache memory, 101 Control section, 122 Prediction section, 113 Orthogonal transformation section, 115 Encoding section, 118 Inverse orthogonal transformation section, 120 In-loop filter section, 212 Decoding section, 214 Inverse orthogonal transformation section, 216 In-loop filter section, 219 Prediction section

1. An image encoding device comprising:
a setting section that sets identification information for identifying a sub-block size that represents a size of a sub-block to be used in an inter-prediction process of an image; and
an encoding section that performs switching to the sub-block having the size set by the setting section, encodes the image by performing the inter-prediction process, and generates a bitstream including the identification information.

2. The image encoding device according to claim 1, wherein
the encoding section performs the inter-prediction process by adopting an affine transformation to the sub-block.

3. The image encoding device according to claim 1, wherein
the encoding section performs the inter-prediction process by adopting FRUC (Frame Rate Up Conversion) to the sub-block.

4. The image encoding device according to claim 1, wherein
in a case where a processing amount required for an application that encodes the image or decodes the bitstream is equal to or less than a predetermined set value, the setting section sets the identification information such that the sub-block size is large.

5. The image encoding device according to claim 1, wherein
the setting section switches the sub-block size in accordance with a prediction direction of the inter-prediction process.

6. The image encoding device according to claim 5, wherein
in a case where the prediction direction of the inter-prediction process is Bi-prediction, the setting section sets the identification information such that the sub-block size is large.

7. The image encoding device according to claim 5, wherein
the setting section sets the identification information such that the sub-block size varies in accordance with whether or not the prediction direction of the inter-prediction process is Bi-prediction.

8. The image encoding device according to claim 1, wherein
in a case where an affine transformation is adopted as the inter-prediction process, the encoding section interpolates a pixel in the inter-prediction process by using an interpolation filter having a shortened tap length.

9. The image encoding device according to claim 8, wherein
the encoding section switches the interpolation filter such that the tap length of the interpolation filter that is used in a case where the affine transformation is adopted as the inter-prediction process differs from the tap length of the interpolation filter that is used in a case where a prediction process other than the affine transformation is adopted as the inter-prediction process.

10. The image encoding device according to claim 9, wherein
the encoding section switches the interpolation filter such that the tap length of the interpolation filter that is used in a case where the affine transformation is adopted as the inter-prediction process is 6 taps, and the tap length of the interpolation filter that is used in a case where a prediction process other than the affine transformation is adopted as the inter-prediction process is 8 taps.

11. The image encoding device according to claim 1, wherein
in a case where an affine transformation is adopted as the inter-prediction process and a prediction direction of the inter-prediction process is Bi-prediction, the encoding section switches the sub-block size, and performs the inter-prediction process.

12. The image encoding device according to claim 11, wherein
in a case where an affine transformation is adopted as the inter-prediction process and a prediction direction of the inter-prediction process is Bi-prediction, the encoding section performs the inter-prediction process by using the sub-block the sub-block size of that is large.

13. The image encoding device according to claim 1, wherein
in a case where an affine transformation is adopted as the inter-prediction process and a prediction direction of the inter-prediction process is Bi-prediction, the encoding section switches the number of taps of an interpolation filter that is used to interpolate a pixel in the inter-prediction process.

14. The image encoding device according to claim 13, wherein
in a case where the affine transformation is adopted as the inter-prediction process and a prediction direction of the inter-prediction process is Bi-prediction, the encoding section interpolates the pixel in the inter-prediction process by using the interpolation filter having a shortened tap length.

15. The image encoding device according to claim 14, wherein
the encoding section adopts the interpolation filter by substituting, for a pixel value of a pixel located outside an image of the sub-block, a pixel value of a nearby pixel.

16. The image encoding device according to claim 15, wherein
the encoding section adopts the interpolation filter by using an image from that the pixel outside the sub-block has been excluded.

17. An image encoding method comprising:
causing an image encoding device, that encodes an image, to set identification information for identifying a sub-block size that represents a size of a sub-block to be used in an inter-prediction process of the image; and
causing the image encoding device to perform switching to the sub-block having the size according to the setting, encode the image by performing the inter-prediction process, and generate a bitstream including the identification information.

18. An image decoding device comprising:
a parse section that parses identification information for identifying a sub-block size, from a bitstream including the identification information, the sub-block size representing a size of a sub-block to be used in an inter-prediction process of an image; and
a decoding section that performs switching to the sub-block having the size according to the identification information parsed by the parse section, performs the inter-prediction process to decode the bitstream, and generates the image.

19. An image decoding method comprising:
causing an image decoding device, that decodes an image, to parse identification information for identifying a sub-block size, from a bitstream including the identification information, the sub-block size representing a size of a sub-block to be used in an inter-prediction process of the image; and
causing the image decoding device to perform switching to the sub-block having the size according to the parsed identification information, perform the inter-prediction process to decode the bitstream, and generate the image.
